(19) United States
(12) Patent Application Publication
(10) Pub. No.: US 2024/0378546 A1
(43) Pub. Date: Nov. 14, 2024

(54) DELIVERY ASSISTANCE APPARATUS, DELIVERY ASSISTANCE METHOD, AND NON-TRANSITORY STORAGE MEDIUM

(71) Applicant: NEC Corporation, Minato-ku, Tokyo (JP)

(72) Inventors: Sho KAWAMOTO, Tokyo (JP); Daisuke KAWASAKI, Tokyo (JP); Kaori YAMANE, Tokyo (JP)

(73) Assignee: NEC Corporation, Minato-ku, Tokyo (JP)

(21) Appl. No.: 18/691,220

(22) PCT Filed: Sep. 29, 2021
(86) PCT No.: PCT/JP2021/035922

§ 371 Date: Mar. 12, 2024

(51) Int. Cl. G06Q 10/0835

(52) U.S. Cl. CPC G06Q 10/0835

(57) ABSTRACT

A delivery assistance apparatus (104) includes a baggage data acquisition unit (115) that acquires destination information of baggage, and an assistance unit (119) that causes, by use of schedule data (108) of an eligible recipient including a recipient determined by the destination information, an output unit (113) to output assistance information indicating a delivery time period or delivery propriety of the baggage.

### TECHNICAL FIELD

The present invention relates to a delivery assistance apparatus, a delivery assistance system, a delivery assistance method, and a program.

### BACKGROUND ART

In delivery of baggage, even when a delivery person delivers the baggage to a delivery destination, the baggage may not be received due to a reason such as absence of a recipient. In such a case, the delivery person ends in redelivering the baggage, and delivery efficiency of the baggage deteriorates. Moreover, for the recipient being a user, inconvenience such as requesting redelivery of the baggage, and waiting at home at a time when the redelivery is requested is caused.

For example, Patent Document 1 describes that an application of a transportation company infers, from home data acquired from a device in a smart home environment, when a resident is at home, and schedules in such a way that delivery is performed at a time when a possibility that persons are at home is highest. Moreover, according to Patent Document 1, the application can also build a delivery route around the scheduled times. According to Patent Document 1, this reduces a situation where the transportation company has to attempt delivery of baggage many times, and reduces the number of times a consumer has to receive his/her baggage from the transportation company.

### RELATED DOCUMENT

### Patent Document

Patent Document 1: Japanese Patent Application Publication No. 2019-169164

### DISCLOSURE OF THE INVENTION

### Technical Problem

However, even at a time when a technique described in Patent Document 1 infers that a possibility of being at home is high, a recipient may actually be absent due to irregular business, urgent business, or the like. Moreover, when working from home, the recipient may not be able to respond to delivery of baggage even though he or she is at home during an online meeting or the like.

The present invention has been made in view of the circumstances described above, and one of objects thereof is to assist improvement in delivery efficiency of baggage. Moreover, one of the objects of the present invention is to improve convenience for a recipient.

### Solution to Problem

In order to achieve the object described above, a delivery assistance apparatus according to a first aspect of the present invention includes:
a baggage information acquisition unit that acquires destination information of baggage; and
an assistance unit that causes, by use of schedule data of an eligible recipient including a recipient determined by the destination information, an output unit to output assistance information indicating a delivery time period or delivery propriety of the baggage.

In order to achieve the object described above, a delivery assistance system according to a second aspect of the present invention includes:
a delivery assistance apparatus including
a baggage information acquisition unit that acquires destination information of baggage, and
an assistance unit that transmits, by use of schedule data of an eligible recipient including a recipient determined by the destination information, assistance information indicating a delivery time period or delivery propriety of the baggage; and
a delivery person terminal including an output unit that outputs the assistance information transmitted from the assistance unit, to a delivery person by an image or sound

In order to achieve the object described above, a delivery assistance method according to a third aspect of the present invention includes:
acquiring destination information of baggage; and
causing, by use of schedule data of an eligible recipient including a recipient determined by the destination information, an output unit to output assistance information indicating a delivery time period or delivery propriety of the baggage.

In order to achieve the object described above, a program according to a fourth aspect of the present invention is a program for causing a computer to execute:
acquiring destination information of baggage; and
causing, by use of schedule data of an eligible recipient including a recipient determined by the destination information, an output unit to output assistance information indicating a delivery time period or delivery propriety of the baggage.

### Advantageous Effects of Invention

According to the present invention, it becomes possible to assist improvement in delivery efficiency of baggage. Moreover, it becomes possible to improve convenience for a consumer.

### BRIEF DESCRIPTION OF THE DRAWINGS

FIG. 1 is a diagram illustrating a configuration of a delivery assistance system according to a first example embodiment of the present invention.

FIG. 2 is a diagram illustrating a functional configuration of a schedule management apparatus according to the first example embodiment.

FIG. 3 is a diagram illustrating one example of schedule data.

FIG. 4 is a diagram illustrating a functional configuration of a recipient terminal according to the first example embodiment.

FIG. 5 is a diagram illustrating a functional configuration of a delivery person terminal according to the first example embodiment.

FIG. 6 is a diagram illustrating a functional configuration of a delivery assistance apparatus according to the first example embodiment.

FIG. 7 is a diagram illustrating one example of baggage data.

FIG. 8 is a diagram illustrating a first example of recipient data.

FIG. 9 is a diagram illustrating one example of delivery scheme data.

FIG. 10 is a diagram illustrating a physical configuration of a recipient terminal according to the first example embodiment.

FIG. 11 is a diagram illustrating a physical configuration of a delivery assistance apparatus according to the first example embodiment.

FIG. 12 is one example of a flowchart of scheme preparation processing according to the first example embodiment of the present invention.

FIG. 13 is a diagram illustrating one example of a screen for displaying assistance information including a delivery time period.

FIG. 14 is one example of a flowchart of first delivery-in-progress processing according to the first example embodiment.

FIG. 15 is one example of a flowchart of second delivery-in-progress processing according to the first example embodiment.

FIG. 16 is one example of a flowchart of propriety assessment processing.

FIG. 17 is a diagram illustrating one example of a screen for displaying assistance information indicating that baggage is deliverable.

FIG. 18 is a diagram illustrating one example of a screen for displaying assistance information indicating that baggage is undeliverable.

FIG. 19 is one example of a flowchart of scheme preparation processing according to a first modified example.

FIG. 20 is a diagram illustrating a second example of recipient data.

FIG. 21 is one example of a flowchart of scheme preparation processing according to a third modified example.

FIG. 22 is a diagram illustrating a physical configuration of a delivery assistance apparatus according to a second example embodiment of the present invention.

FIG. 23 is one example of a flowchart of notification processing according to the second example embodiment of the present invention.

FIG. 24 is one example of a flowchart of notification processing according to a fourth modified example.

FIG. 25 is a diagram illustrating a functional configuration of a delivery assistance apparatus according to a fifth modified example.

FIG. 26 is one example of a flowchart of inquiry processing according to the fifth modified example.

FIG. 27 is one example of a flowchart of inquiry processing according to a sixth modified example.

FIG. 28 is a diagram illustrating a physical configuration of a delivery assistance apparatus according to a third example embodiment of the present invention.

FIG. 29 is one example of a flowchart of update processing according to the third example embodiment of the present invention.

FIG. 30 is one example of a flowchart of update processing according to a seventh modified example.

FIG. 31 is one example of a flowchart of update processing according to an eighth modified example.

### DESCRIPTION OF EMBODIMENTS

Hereinafter, example embodiments of the present invention are described by use of the drawings. Note that, a similar reference sign is assigned to a similar component in all the drawings, and description is omitted as appropriate.

### First Example Embodiment

### <Configuration of Delivery Assistance System 100>

A delivery assistance system 100 according to a first example embodiment of the present invention is a system for assisting delivery of baggage, and assists in delivery of baggage by use of a schedule of a recipient of the baggage or the like.

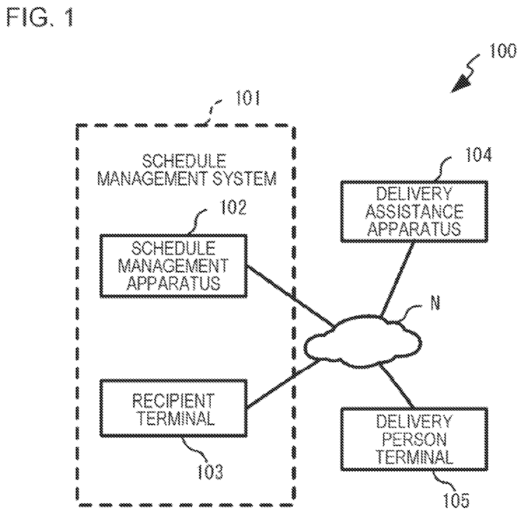

The delivery assistance system 100 includes, as illustrated in FIG. 1, a schedule management system 101 including a schedule management apparatus 102 and a recipient terminal 103, a delivery assistance apparatus 104, and a delivery person terminal 105.

The delivery assistance apparatus 104 is connected to each of the recipient terminal 103, the schedule management apparatus 102, and the delivery person terminal 105 via the network N in such a way that information can be transmitted and received to and from each other.

Note that, the recipient terminal 103, the schedule management apparatus 102, and the delivery person terminal 105 provided in the delivery assistance system 100 may each be plural.

### (Configuration of Schedule Management System 101)

A schedule management system 101 is a system for managing a schedule of a user, and includes the recipient terminal 103 and the schedule management apparatus 102 that are connected in such a way that information can be transmitted and received to and from each other via a network N. The schedule management system 101 may be a general system that provides a schedule management service, and one example thereof is described in the present example embodiment.

### (Functional Configuration of Schedule Management Apparatus 102)

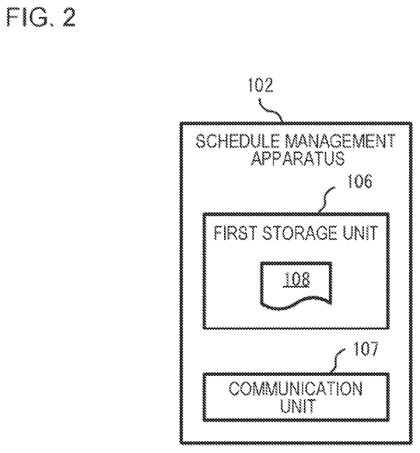

The schedule management apparatus 102 is an apparatus for managing a schedule of a user. The schedule management apparatus 102 functionally includes a first storage unit 106 and a communication unit 107 as illustrated in FIG. 2.

The first storage unit 106 is a storage unit that stores various types of information. Information stored in the first storage unit 106 is, for example, schedule data 108.

### (Configuration Example of Schedule Data 108)

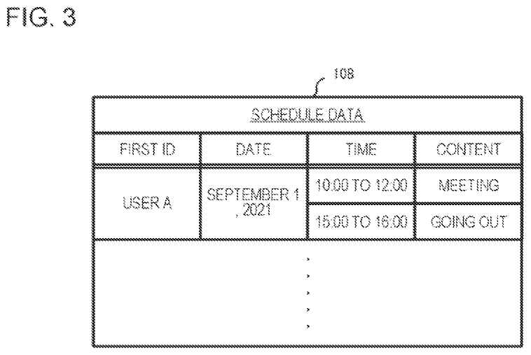

The schedule data 108 are data indicating a plan of a user, and, as one example thereof is illustrated in FIG. 3, include a first identification (ID), a date, a time, and a content, which are associated with each other.

The first ID is information for identifying a user in the schedule management system 101. The date, the time, and the content associated with each other in the schedule data 108 indicate a date, a time, and a content relating to a common schedule, respectively. Then, the first ID of the schedule data 108 is associated with a date, a time, and a content relating to a plan of a user identified by the first ID.

In a detailed example of the schedule data 108 illustrated in the figure, a plan regarding a user identified by “user A” is set. The plan is “meeting” for “10:00 to 12:00” on “Sep. 1, 2021” and “going out” for “15:00 to 16:00” on the same date.

Note that, the schedule data 108 may be set to another plan of the user identified by “user A” and a plan of a user other than the user identified by “user A”. Moreover, the time may be set not only to a time slot but also to a time instant.

FIG. 2 is referred to again.

The communication unit 107 transmits and receives information via network N. Moreover, the communication unit 107 performs transmission, registration, change, deletion, and the like of the schedule data 108 in response to a request acquired via the network N.

### (Functional Configuration of Recipient Terminal 103)

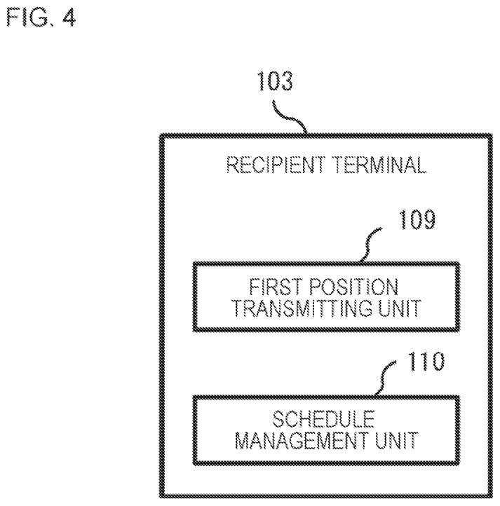

The recipient terminal 103 is an apparatus owned by a recipient of baggage, and functionally includes a first position transmitting unit 109 and a schedule management unit 110, as illustrated in FIG. 4.

The first position transmitting unit 109 acquires a current position of the recipient terminal 103, and transmits first position information indicating the current position to the delivery assistance apparatus 104 via a network.

The schedule management unit 110 performs processing for managing, via the network N, the schedule data 108 of the recipient who is a user of the schedule management system 101. The schedule management unit 110 causes the schedule management apparatus 102 to perform transmission, registration, change, deletion, and the like of the schedule data 108 in response to, for example, input of the recipient. Thereby, the recipient can manage his own schedule as a user of the schedule management system 101.

As may be understood from this description, the schedule management unit 110 is a function that the recipient terminal 103 includes as an apparatus constituting the schedule management system 101. That is to say, the recipient terminal 103 constitutes the schedule management system 101 in including the schedule management unit 110. The schedule management unit 110 may be provided in the recipient terminal 103, or, instead of being provided in the recipient terminal 103, may be provided in an appropriate information processing apparatus, such as a computer, connected to the network N.

### (Functional Configuration of Delivery Person Terminal 105)

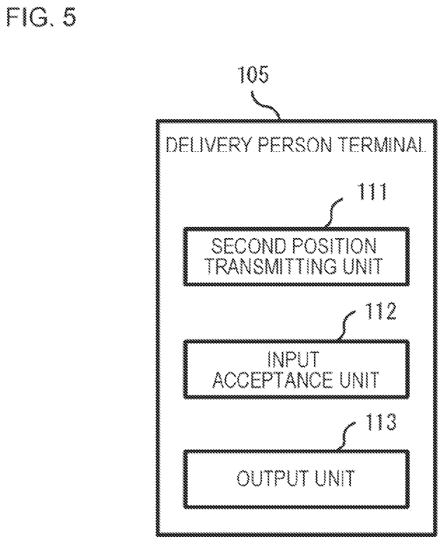

The delivery person terminal 105 is an apparatus owned by a delivery person of baggage, and functionally includes a second position transmitting unit 111, an input acceptance unit 112, and an output unit 113, as illustrated in FIG. 5.

The second position transmitting unit 111 acquires a current position of the delivery person terminal 105, and transmits second position information indicating the current position to the delivery assistance apparatus 104 via a network.

The input acceptance unit 112 accepts input from the delivery person.

The output unit 113 displays various types of information. Thereby, the delivery person can view various types of information. The output unit 113 is equivalent to an output unit.

Note that, a method of output by the output unit 113 as an output unit is not limited to display, and, for example, sound may be adopted together with display or instead of display.

### (Functional Configuration of Delivery Assistance Apparatus 104)

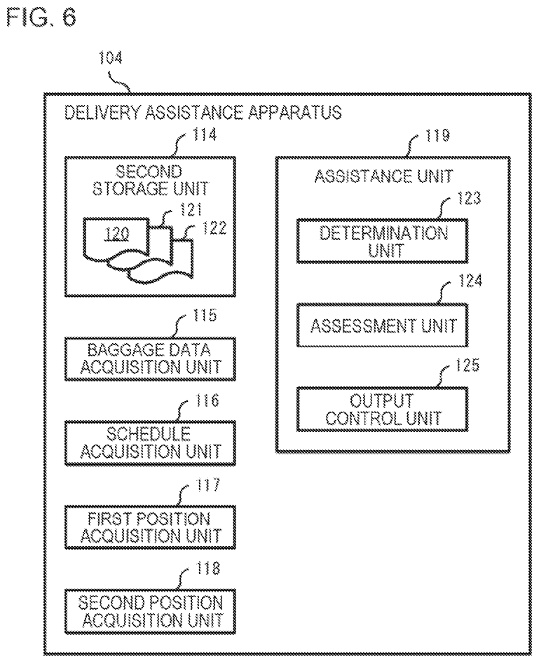

The delivery assistance apparatus 104 is an apparatus for assisting delivery of baggage. As illustrated in FIG. 6, the delivery assistance apparatus 104 functionally includes a second storage unit 114, a baggage data acquisition unit 115, a schedule acquisition unit 116, a first position acquisition unit 117, a second position acquisition unit 118, and an assistance unit 119.

The second storage unit 114 is a storage unit that stores various types of information. Information stored in the second storage unit 114 includes, for example, baggage data 120, recipient data 121, and delivery scheme data 122.

### (Configuration Example of Baggage Data 120)

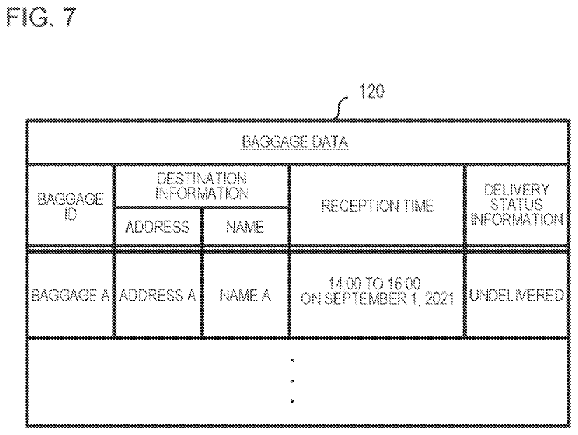

The baggage data 120 are data relating to baggage to be a target for delivery. The baggage data 120 according to the present example embodiment include, as one example thereof is illustrated in FIG. 7, a baggage ID, destination information, a reception time, and completion information, which are associated with each other.

The baggage ID is information for identifying baggage in the delivery assistance system 100. The destination information is information indicating a destination of the baggage, and includes an address and a name indicating the destination of the baggage in the present example embodiment. The baggage ID and the destination information are set, for example, at such a time that shipment of baggage is accepted.

The reception time is information indicating a reception time of baggage specified by a recipient, and includes a date and a time slot specified by the recipient. The reception time is set according to specification of the recipient, and is set, for example, by specification from a recipient who has received a delivery plan of baggage or an absence notification (a notification that the recipient was absent at delivery of the baggage). That is to say, when there is no specification from the recipient, no reception time may be set.

Delivery status information is information indicating status of delivery of baggage. Status of delivery of baggage includes, for example, “undelivered”, “delivery complete”, and “redelivery”. “Undelivered” indicates that baggage has not yet been delivered. “Delivery complete” indicates that baggage has been handed over to a recipient, and delivery has been completed. “Redelivery” indicates that baggage was delivered but could not be handed over to a recipient and is a target for redelivery.

A baggage ID of the baggage data 120 is associated with the destination information, a reception time, and completion information of baggage identified by the baggage ID.

A detailed example of the baggage data 120 illustrated in the figure indicates that an address and a name of a destination of baggage identified by “baggage A” are “address A” and “name A”, respectively, and a reception time specified regarding the baggage is “14:00 to 16:00 on Sep. 1, 2021”. Moreover, a detailed example of the baggage data 120 illustrated in the figure indicates that, regarding the baggage, delivery has not yet been delivered.

Note that, the baggage data 120 may be set to data relating to baggage other than the baggage identified by “baggage A”. Moreover, the destination information is not limited to an address and a name, and may be information that can determine a recipient of baggage in the delivery assistance system 100, such as information appropriately given to identify the recipient.

### (Configuration Example of Recipient Data 121)

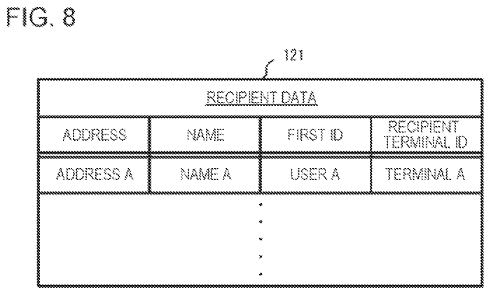

The recipient data 121 are data relating to a recipient previously registered as a user of the delivery assistance system 100. The recipient data 121 according to the present example embodiment include, as one example thereof is illustrated in FIG. 8, an address, a name, a first ID, and a recipient terminal ID, which are associated with each other.

The address and the name associated with each other in the recipient data 121 indicate an address and a name of a recipient, respectively. The first ID of recipient data 121 is relevant to a first ID of the schedule data 108. The recipient terminal ID is information for identifying the recipient terminal 103, and a contact point of the recipient terminal 103 is set.

The address and the name of the recipient data 121 are associated with a first ID of a recipient determined by the address and the name, and a recipient terminal ID of the recipient terminal 103 owned by the recipient.

A detailed example of the recipient data 121 illustrated in the figure indicates that a first ID and a recipient terminal ID of a recipient whose address and name are determined by “address A” and “name A”, respectively, are “user A” and “terminal A”, respectively.

Note that, the recipient data 121 may be set to data relating to a recipient other than a recipient determined by “address A” and “name A”. Moreover, an address and a name of the recipient data 121 may be information that can determine a recipient of baggage in the delivery assistance system 100, similar to the destination information of the baggage data 120.

### (Configuration Example of Delivery Scheme Data 122)

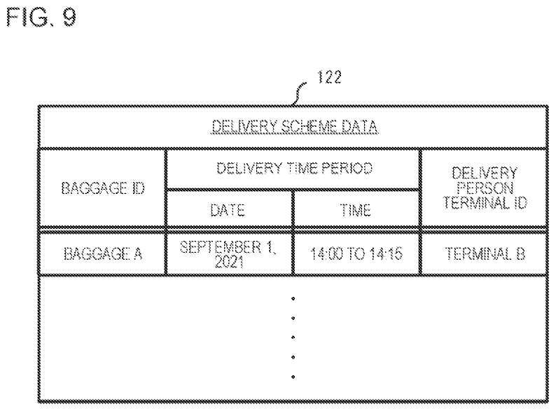

The delivery scheme data 122 are data indicating a delivery scheme of baggage, and are prepared by the assistance unit 119 as described later. The delivery scheme data 122 according to the present example embodiment include, as one example thereof is illustrated in FIG. 9, a baggage ID, a delivery time period, and a delivery person terminal ID, which are associated with each other.

The baggage ID of the delivery scheme data 122 is relevant to the baggage ID of the baggage data 120. The delivery time period is information indicating a time period when baggage is planned to be delivered in a delivery scheme, and includes a date and a time when the baggage is planned to be delivered in the present example embodiment. The delivery person terminal ID is information for identifying the delivery person terminal 105 owned by a delivery person, and a contact point of the delivery person terminal 105 is set.

The baggage ID of the delivery scheme data 122 according to the present example embodiment is associated with a delivery time period of baggage identified by the baggage ID, and a delivery person terminal ID of a delivery person in charge of the delivery.

A detailed example of the delivery scheme data 122 illustrated in the figure indicates that a date and a time of a delivery time period of baggage identified by the “baggage A” are “Sep. 1, 2021” and “14:00 to 14:15”, respectively. Moreover, the detailed example of the delivery scheme data 122 illustrated in the figure indicates that a delivery person terminal ID of a delivery person in charge of delivery of the baggage is “terminal B”.

Note that, data relating to pieces of baggage other than the baggage identified by “baggage A” may be set in the delivery scheme data 122. Moreover, when, for example, a delivery scheme is prepared regarding a specific day, a delivery time period may be only a time, and the time may be set not only to a time slot but also to a time instant.

FIG. 6 is referred to again.

The baggage data acquisition unit 115 acquires baggage data 120 including destination information and the like of baggage. The baggage data acquisition unit 115 is equivalent to a baggage information acquisition unit. The schedule acquisition unit 116 acquires the schedule data 108 of a recipient. The first position acquisition unit 117 acquires first position information. The second position acquisition unit 118 acquires second position information.

The assistance unit 119 causes the output unit 113 to output assistance information, by use of the schedule data 108 of the recipient determined by the destination information of the baggage acquired by the baggage data acquisition unit 115. The assistance information is information for assisting delivery of the baggage, and indicates a delivery time period or delivery propriety of the baggage.

Specifically, the assistance unit 119 includes a determination unit 123, an assessment unit 124, and an output control unit 125, as illustrated in the figure.

The determination unit 123 determines a delivery time period of baggage, by use of the schedule data 108 of a recipient. Thereby, a delivery scheme of the baggage is prepared, and delivery scheme data 122 indicating the prepared delivery scheme are stored in the second storage unit 114 by the determination unit 123.

The assessment unit 124 assesses, by use of a current position and the schedule data 108 of the recipient, delivery propriety of the baggage in a delivery time period of the baggage.

Note that, although the present example embodiment is described with an example in which delivery propriety of baggage is assessed by use of both a current position and the schedule data 108 of a recipient, delivery propriety of baggage may be assessed by use of at least one of a current position and the schedule data 108 of a recipient.

The output control unit 125 transmits, to the delivery person terminal 105 via the network N, assistance information indicating a delivery time period determined by the determination unit 123 or delivery propriety determined by the assessment unit 124. Thereby, the output control unit 125 causes the output unit 113 to display the assistance information.

So far, a functional configuration of the delivery assistance system 100 according to the first example embodiment of the present invention has been mainly described. From here, a physical configuration of the delivery assistance system 100 is described.

### (Physical Configuration of Delivery Assistance System 100)

A delivery assistance system 100 according to the present example embodiment is physically constituted of a schedule management apparatus 102, a recipient terminal 103, a delivery assistance apparatus 104, and a delivery person terminal 105, which are connected via a network N. The network N may be constructed by, for example, a wired line, a wireless line, or a combinational line thereof.

### (Physical Configuration of Schedule Management Apparatus 102)

The schedule management apparatus 102 is, for example, a general-purpose computer or the like, and may be configured physically similar to the delivery assistance apparatus 104. Details of a physical configuration of the schedule management apparatus 102 is described later in connection with description of the physical configuration of the delivery assistance apparatus 104.

### (Physical Configuration of Recipient Terminal 103)

The recipient terminal 103 is physically, for example, a tablet personal computer (PC), a smartphone, or the like.

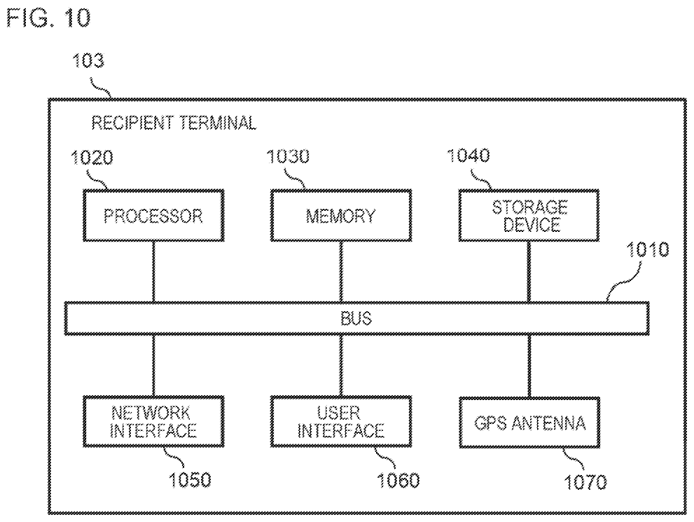

Specifically, for example, as illustrated in FIG. 10, the recipient terminal 103 physically includes a bus 1010, a processor 1020, a memory 1030, a storage device 1040, a network interface 1050, a user interface 1060, and a global positioning system (GPS) antenna 1070.

The bus 1010 is a data transmission path through which the processor 1020, the memory 1030, the storage device 1040, the network interface 1050, the user interface 1060, and the GPS antenna 1070 transmit and receive data to and from each other. However, a method of connecting the processor 1020 and the like to each other is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function of the recipient terminal 103. The processor 1020 reads each of the program modules onto the memory 1030, executes the read program module, and thereby achieves a function of the recipient terminal 103 being relevant to the program module.

The network interface 1060 is an interface for connecting the recipient terminal 103 to the network N.

The user interface 1060 is a touch panel, a keyboard, a mouse, or the like as an interface for a user to input information, and a liquid crystal panel or the like as an interface for presenting information to a user.

The GPS antenna 1070 is an antenna for acquiring a current position of the recipient terminal 103 by utilizing a GPS.

Note that, the GPS antenna 1070 is one example of a physical configuration for acquiring a current position of the recipient terminal 103. For acquisition of a current position, a conventional technique utilizing some or all of a GPS, base station position information, radio frequency identification (RFID), a wireless local area network (LAN), and the like may be adopted. Then, physically, an antenna according to a method for acquiring a current position may be provided.

### (Physical Configuration of Delivery Person Terminal 105)

The delivery person terminal 105 is physically, for example, a tablet personal computer (PC), a smartphone, or the like.

Specifically, for example, a physical configuration of the delivery person terminal 105 may be substantially similar to that of the recipient terminal 103, and is a replacement of the “recipient terminal 103” in the above description relating to the physical configuration of the recipient terminal 103 with the “delivery person terminal 105”.

### (Physical Configuration of Delivery Assistance Apparatus 104)

The delivery assistance apparatus 104 is physically, for example, a general-purpose computer or the like.

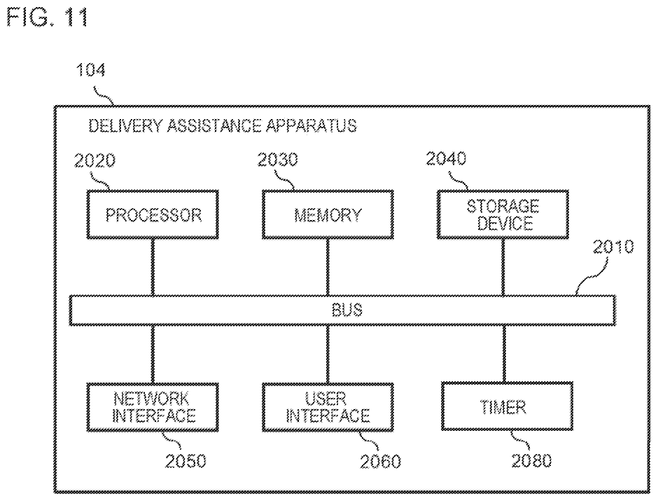

Specifically, for example, as illustrated in FIG. 11, the delivery assistance apparatus 104 physically includes a bus 2010, a processor 2020, a memory 2030, a storage device 2040, a network interface 2050, a user interface 2060, and a timer 2080.

The bus 2010 is a data transmission path through which the processor 2020, the memory 2030, the storage device 2040, the network interface 2050, the user interface 2060, and the timer 2080 transmit and receive data to and from each other. However, a method of connecting the processor 2020 and the like to each other is not limited to bus connection.

The processor 2020, the memory 2030, the storage device 2040, the network interface 2050, and the user interface 2060 may be similar to the processor 1020, the memory 1030, the storage device 1040, the network interface 1050, and the user interface 1060 described above, respectively.

The storage device 2040 stores a program module that achieves each function of the delivery assistance apparatus 104. The processor 2020 reads each of the program modules onto the memory 2030, executes the read program module, and thereby achieves a function of the delivery assistance apparatus 104 being relevant to the program module.

The network interface 2060 is an interface for connecting a delivery assistance apparatus to the network N.

The timer 2080 is an apparatus that measures time, and is utilized, for example, in order to acquire a current time instant.

Herein, the schedule management apparatus 102 is physically configured substantially similarly to the delivery assistance apparatus 104, as described above. Specifically, for example, the physical configuration of the schedule management apparatus 102 is a replacement of the “delivery assistance apparatus 104” in the above description relating to the physical configuration of the delivery assistance apparatus 104 with “schedule management apparatus 102”.

### <<Operation of Delivery Assistance System 100>>

From here, an operation of the delivery assistance system 100 is described with reference to the drawings.

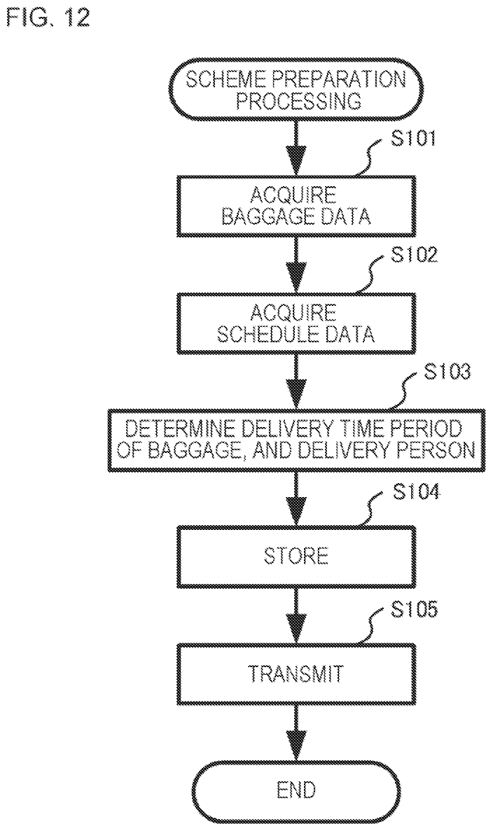

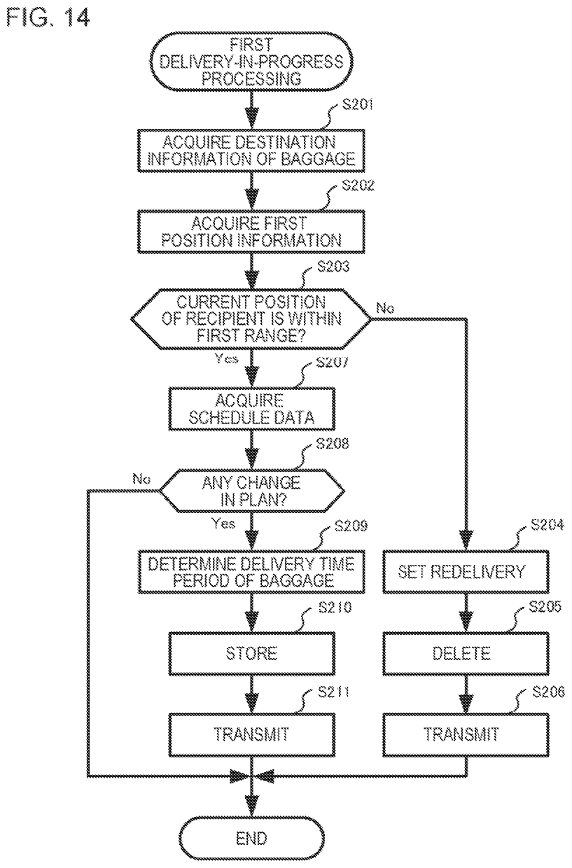

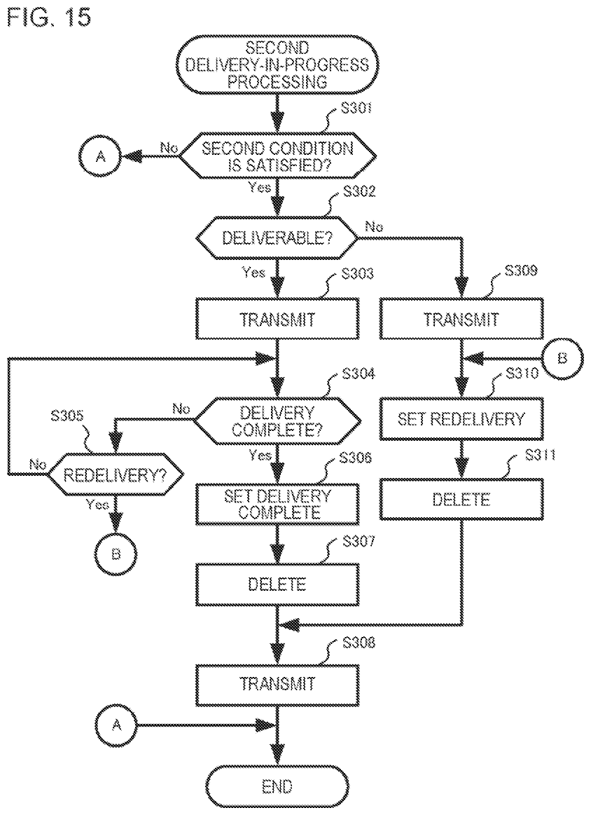

The delivery assistance system 100 executes a delivery assistance method for assisting delivery of baggage. The delivery assistance method includes scheme preparation processing illustrated in FIG. 12, and first delivery-in-progress processing and second delivery-in-progress processing illustrated in FIGS. 14 and 15, respectively.

### (Scheme Preparation Processing)

FIG. 12 is a flowchart illustrating one example of scheme preparation processing according to the present example embodiment. The scheme preparation processing is processing of preparing, for baggage planned to be delivered in a previously determined target period, a delivery scheme of the baggage.

The target period is a delivery time in a day, a previously determined time slot within a delivery time in a day, and the like. The delivery time in a day is, for example, 9:00 to 21:00, a time slot of the delivery time is a time slot acquired by dividing 9:00 to 21:00, and one of the divided time slots is, for example, 14:00 to 16:00. There are usually a plurality of pieces of baggage to be a target for the scheme preparation processing. Note that, the number of pieces of baggage to be a target for the scheme preparation processing may be one.

The scheme preparation processing is started in response to an instruction to the delivery assistance apparatus 104 before start of a target period. For example, when a delivery scheme for a day is prepared, the scheme preparation processing is executed before delivery for the day is started.

The baggage data acquisition unit 115 refers to the second storage unit 114, and acquires the baggage data 120 of baggage planned to be delivered in the target period (step S101).

Specifically, the baggage data acquisition unit 115 extracts the baggage data 120 of baggage excluding baggage for which a reception time outside the target period is set. That is to say, the baggage data acquisition unit 115 extracts the baggage data 120 of baggage whose reception time is included in the target period, and baggage whose reception time is not set.

Then, the baggage data acquisition unit 115 acquires the baggage data 120 of the extracted baggage. Thereby, the baggage data acquisition unit 115 acquires the baggage data 120 associated with a baggage ID, destination information, and a reception time of the baggage planned to be delivered in the target period.

For example, when a target period is from 9:00 to 21:00 on Sep. 1, 2021, the baggage data 120 acquired in step S101 include the baggage data 120 of baggage whose baggage ID illustrated in FIG. 7 is “baggage A”.

FIG. 12 is referred to again.

The schedule acquisition unit 116 acquires, from the schedule management apparatus 102, the schedule data 108 of the recipient determined by the destination information acquired in step S101 (step S102).

Specifically, the schedule acquisition unit 116 refers to the second storage unit 114, and acquires the first ID associated in the recipient data 121 with the destination information acquired in step S101. Thereby, the first ID of the recipient determined by the destination information acquired in step S101 can be acquired. The schedule acquisition unit 116 acquires, from the schedule management apparatus 102, the schedule data 108, indicating a plan for a target period, of a user identified by the acquired first ID.

For example, in step S101, when the baggage data 120 of the baggage whose baggage ID is illustrated in FIG. 7 is “baggage A”, a recipient of the baggage is determined by “address A” and “name A” included in the destination information of the baggage. The schedule acquisition unit 116 refers to the second storage unit 114, and acquires the “user A” as the first ID associated with “address A” and “name A” in the recipient data 121.

The schedule acquisition unit 116 transmits, to the schedule management apparatus 102, a request for a schedule including “user A” being the acquired first ID, and “9:00 to 21:00. on Sep. 1, 2021” being a target period. When the request is acquired, the communication unit 107 refers to the first storage unit 106, and extracts the schedule data 108 (refer to FIG. 3) indicating a plan at “9:00 to 21:00 on Sep. 1, 2021” of “user A” being the first ID. The communication unit 107 transmits the extracted schedule data 108 to the delivery assistance apparatus 104.

Thereby, the schedule acquisition unit 116 acquires, from the schedule management apparatus 102, the schedule data 108 of the recipient determined by the “address A” and “name A” that are the destination information acquired in step S101.

FIG. 12 is referred to again.

By use of the schedule data 108 acquired in step S102, the determination unit 123 determines a delivery time period of baggage, and determines a delivery person of the baggage (step S103).

Specifically, in a case of baggage for which a reception time is not set in the baggage data 120 acquired in step S101, the determination unit 123 determines a delivery time period of baggage by use of the schedule data 108 acquired in step S102. Moreover, in a case of baggage for which a reception time is set in the baggage data 120 acquired in step S101, the determination unit 123 determines a delivery time period of the baggage by use of the reception time, and the schedule data 108 acquired in step S102.

For example, in step S101, when the baggage data 120 of the baggage whose baggage ID illustrated in FIG. 7 is “baggage A” are acquired, a reception time being “14:00 to 16:00 on Sep. 1, 2021” is set for the baggage. In this case, the determination unit 123 determines a delivery time period of the baggage in such a way that the baggage is delivered at a time when a plan of a recipient is free within the reception time.

For example, when the schedule data 108 illustrated in FIG. 3 are acquired in step S102, the recipient whose first ID is “user A” has a plan of “going out” at “15:00 to 16:00” within “14:00 to 16:00 on Sep. 1, 2021” being a reception time.

Thus, the determination unit 123 determines that a deliverable time of the baggage whose baggage ID is “baggage A” is 14:00 to 15:00 on Sep. 1, 2021. Then, the determination unit 123 determines a delivery time period whose baggage ID of “baggage A” to be “14:00 to 14:15 on Sep. 1, 2021”, for example, as illustrated in FIG. 9.

Which time of deliverable times to be a delivery time period may be determined by an appropriate method. For example, an early time slot may be allocated to a delivery time period in an order in which determination processing of a delivery time period is executed. Moreover, a delivery time period may be appropriately adjusted in relation to a reception time of another piece of baggage and the like. Further, when a delivery time period is determined by a time slot as in the present example embodiment, not only one piece of baggage but also a plurality of pieces of baggage may be allocated to a delivery time period.

In this way, the determination unit 123 determines a delivery time period for each piece of baggage for which a reception time has been set.

Then, when there is baggage for which a reception time is not set, the determination unit 123 appoints, as a deliverable time for the baggage, a time to which a delivery time period is not allocated, and determines a delivery time period of the baggage. As described above, the schedule data 108 are also used when a delivery time period of baggage for which a reception time is not set is determined, and a delivery time period of the baggage is determined in such a way that the baggage is delivered at a time when a plan of a recipient is free within a receivable time.

Further, the determination unit 123 determines a delivery person of baggage whose delivery time period is determined, by use of delivery person data (not illustrated) previously stored in the second storage unit 114. Alternatively, the determination unit 123 determines a delivery person of baggage whose delivery time period is determined, according to input to the delivery assistance apparatus 104 performed by referring to, for example, displayed delivery person data.

Herein, the delivery person data are data associating a delivery person ID for identifying a delivery person in charge of delivery in a target period with a delivery person terminal ID of a delivery person terminal 105 owned by the delivery person.

FIG. 12 is referred to again.

The determination unit 123 stores, in the second storage unit 114, the delivery scheme data 122 associating a baggage ID of each piece of baggage determined in step S103, the delivery time period, and a delivery person terminal ID of the delivery person (step S104).

The output control unit 125 transmits assistance information including the baggage ID and the delivery time period determined in step S103 regarding baggage to be delivered by the delivery person, to the delivery person terminal 105 indicated by the delivery person terminal ID of the delivery person determined in step S103 (step S105). Thereby, the output control unit 125 ends the scheme preparation processing.

The assistance information transmitted from the output control unit 125 is acquired by the delivery person terminal 105. When the assistance information is acquired, the output unit 113 automatically displays the assistance information, for example, according to an instruction of the delivery person or regardless of an instruction of the delivery person. That is to say, the output control unit 125 transmits assistance information, and thereby causes the output unit 113 to display the assistance information.

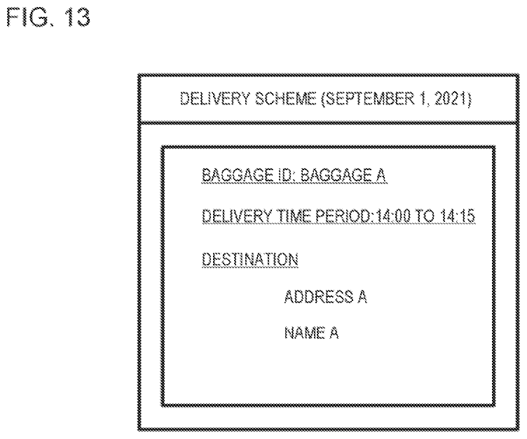

Herein, FIG. 13 is a diagram illustrating one example of a screen of the output unit 113 displaying assistance information including a delivery time period. The figure illustrates an example of a screen including assistance information for baggage whose baggage ID is “baggage A”, and assistance information of another piece of baggage can be viewed, for example, by scrolling the screen. Thereby, the delivery person can view a delivery scheme of baggage prepared by the delivery assistance apparatus 104.

Moreover, destination information is generally indicated on baggage by attachment of a sticker or the like. Moreover, the sticker or the like may indicate a baggage ID by a code constituted of a number, a letter, or the like, a code (a bar code, a two-dimensional code, or the like) readable by the delivery person terminal 105, or the like. Which actual baggage the baggage indicated by the assistance information is relevant to can be found out by the destination information or the baggage ID. Thereby, the delivery person can deliver the baggage according to the delivery scheme.

The scheme preparation processing according to the present example embodiment prepares a delivery scheme with reference to a plan of a recipient. Thus, a possibility that a recipient cannot receive baggage at delivery, such as absence of a recipient, or a situation where a recipient is at an address but cannot respond to delivery of the baggage, can be reduced. Therefore, it becomes possible to assist an improvement in delivery efficiency of baggage. Moreover, a reduction of effort for receiving baggage, such as effort for a recipient to respond to redelivery, can be made. Therefore, it becomes possible to make an improvement in convenience for a recipient.

Note that, the assistance information may include a reception time of the baggage data 120 of baggage to be a target for delivery assistance.

### (First Delivery-In-Progress Processing)

FIG. 14 is a flowchart illustrating one example of first delivery-in-progress processing according to the present example embodiment. The first delivery-in-progress processing is processing for correcting a delivery scheme prepared by the scheme preparation processing, as necessary, while a delivery person is delivering baggage according to the delivery scheme.

The first delivery-in-progress processing is started for baggage, for example, when a current time instant becomes a previously determined first time (e.g., a time of 10 to 30 minutes) before a delivery time period (in the present example embodiment, a start time of a delivery time period) of baggage. That is to say, baggage to be a target for the first delivery-in-progress processing is baggage whose delivery time period (a start time of a delivery time period) comes after the first time from the current time instant.

The baggage data acquisition unit 115 refers to the second storage unit 114, and acquires the baggage data 120 of baggage being a target of processing (step S201).

The first position acquisition unit 117 acquires first position information by inquiring of the recipient terminal 103 of a recipient of the baggage to be a target of the first delivery-in-progress processing about a current position (step S202).

Specifically, the first position acquisition unit 117 refers to the second storage unit 114, and acquires a recipient terminal ID of the recipient data 121 including an address and a name included in the baggage data 120 acquired in step S201. Then, the first position acquisition unit 117 inquires of the recipient terminal 103 indicated by the acquired recipient terminal ID about a current position. When receiving the inquiry, the first position transmitting unit 109 acquires the current position, and transmits first position information indicating the acquired current position to the delivery assistance apparatus 104. Thereby, the first position acquisition unit 117 acquires a current position of the recipient of baggage to be a target.

The schedule acquisition unit 116 assesses, by use of the first position information acquired in step S202, whether a current position of the recipient is within a previously determined first range (step S203).

Herein, for the first range, the recipient is an address or a vicinity thereof is set. The vicinity of the address is a range previously determined from the address. The range is a range that a recipient can normally move in the first time, for example, a range of about several hundred meters when the first time is 30 minutes.

As described above, baggage is delivered substantially the first time after the first delivery-in-progress processing. When a recipient is at an address or in a vicinity thereof, the recipient has a high possibility of being at the address normally within the first time. On the contrary, when the recipient is neither at the address nor in a vicinity thereof, the recipient has a low possibility of being at the address after the first time. Thus, by the assessment processing in step S203, whether the recipient has a high possibility of being at the address at a time when the baggage is planned to be delivered can be determined.

“Being within the first range” in step S203 according to the present example embodiment is one example of a previously determined first condition.

When a current position of the recipient is not within the first range (step S203: No), the determination unit 123 sets “redelivery” in delivery status information of the baggage data 120 of baggage being a target for processing (step S204).

Thereby, the baggage being the target of the first delivery-in-progress processing is treated as a target for redelivery. Note that, the baggage for redelivery is combined with baggage to be a target for a delivery scheme at, for example, a reception time on a next day or later specified by the recipient.

The determination unit 123 deletes, from the second storage unit 114, the delivery scheme data 122 relating to the baggage being a target of the first delivery-in-progress processing (step S205).

Thereby, the baggage being a target of the first delivery-in-progress processing has become a target for redelivery, and is therefore excluded from the baggage to be delivered in the target period of the delivery scheme, and the delivery scheme is corrected.

Note that, in step S205, in addition to the processing described above, a delivery time period may be determined again by a method similar to that in step S103, regarding undelivered baggage to be delivered in the target period by the same delivery person as the baggage being a target of the first delivery-in-progress processing.

The output control unit 125 transmits, to the delivery person terminal 105 of a delivery person of baggage being a target of the first delivery-in-progress processing, assistance information including a baggage ID and a delivery time period included in the delivery scheme data 122 of baggage to be delivered by the delivery person (step S206). Thereby, the output control unit 125 ends the first delivery-in-progress processing.

Specifically, the output control unit 125 acquires, from the second storage unit 114, the delivery scheme data 122 in which the delivery person terminal ID is the same as the delivery scheme data 122 deleted in step S205, and the delivery status information is “undelivered”. Thereby, the delivery scheme data 122 of the undelivered baggage to be delivered in the target period by the same delivery person as the baggage being a target of the first delivery-in-progress processing is acquired.

Then, the output control unit 125 transmits, to the delivery person terminal 105 indicated by the delivery person terminal ID, assistance information including the baggage ID and the delivery time period included in the acquired delivery scheme data 122.

Thereby, the delivery person can deliver the baggage according to the corrected delivery scheme, as described in the scheme preparation processing. When a current position of the recipient is within the first range (step S203: Yes), the schedule acquisition unit 116 acquires the schedule data 108 of the recipient determined by the destination information acquired in step S201 (step S207).

Details of the processing in step S202 are substantially similar to those of the processing in step S102.

The determination unit 123 determines whether there is a change in a plan of the recipient determined by the destination information acquired in step S201 (step S208).

Specifically, the determination unit 123 compares pieces of the schedule data 108 acquired in steps S207 and S102, regarding the common recipient. The processing in step S102 herein is in the scheme preparation processing when a delivery scheme being a target for correction is prepared in the first delivery-in-progress processing, and the schedule data 108 acquired in step S102 may be stored in, for example, the second storage unit 114.

When it is determined that there is no change in the plan (step S208: No), the determination unit 123 ends the first delivery-in-progress processing.

When it is determined that there is a change in the plan (step S208: Yes), the determination unit 123 determines the delivery time period of the baggage by use of the schedule data 108 acquired in step S207 (step S209).

In step S209, regarding undelivered baggage to be delivered in a target period by the same delivery person as the baggage being a target of the first delivery-in-progress processing, a delivery time period is determined again by a method similar to the determination method of the delivery time period in step S103. In this instance, the schedule data 108 acquired in step S207 are used for determination of a delivery time period. In addition, the schedule data 108 of a recipient of another piece of undelivered baggage may also be acquired again by the schedule acquisition unit 116, and the schedule data 108 may also be used for determination of a delivery time period.

The determination unit 123 stores the delivery scheme data 122 indicating a corrected delivery scheme in the second storage unit 114 (step S210).

Specifically, the determination unit 123 updates a delivery time period in the delivery scheme data 122 by the delivery time period determined in step S209, regarding baggage whose delivery time period determined in step S209 is different from the delivery time period determined in step S103. The processing in step S102 herein is in the scheme preparation processing when the delivery scheme being a target of correction in the first delivery-in-progress processing is prepared.

The output control unit 125 transmits, to the delivery person terminal 105 of a delivery person of baggage being a target of the first delivery-in-progress processing, assistance information including a baggage ID and a delivery time period included in the delivery scheme data 122 of the baggage to be delivered by the delivery person (step S206). Thereby, the output control unit 125 ends the first delivery-in-progress processing.

Specifically, the output control unit 125 acquires, from the second storage unit 114, the delivery scheme data 122 having the same delivery person terminal ID as the delivery scheme data 122 of baggage being a target of the first delivery-in-progress processing and having delivery status information being “undelivered”. Thereby, the delivery scheme data 122 indicating a corrected delivery scheme is acquired regarding undelivered baggage to be delivered in a target period by the same delivery person as the baggage being a target of the first delivery-in-progress processing.

Then, the output control unit 125 transmits, to the delivery person terminal 105 indicated by the delivery person terminal ID, assistance information including the baggage ID and the delivery time period included in the acquired delivery scheme data 122.

The first delivery-in-progress processing according to the present example embodiment prepares a delivery scheme with reference to a plan of a recipient, when a current position of the recipient is within the first range. When a current position of the recipient is within the first range, the recipient has a high possibility of being at an address being a delivery destination of baggage, at a time when the baggage is planned to be delivered. In this case, by further referring to the plan and preparing a delivery scheme, for example, a possibility that the recipient is in a situation where the recipient is at the address but cannot respond to delivery of the baggage can be further reduced.

Therefore, it becomes possible to assist a further improvement in delivery efficiency of baggage. Moreover, a further reduction of effort for receiving baggage, such as effort for a recipient to respond to redelivery, can be made. Therefore, it becomes possible to make a further improvement in convenience for a recipient.

### (Second Delivery-In-Progress Processing)

FIG. 15 is a flowchart illustrating one example of the second delivery-in-progress processing according to the present example embodiment. The second delivery-in-progress processing is processing for assessing delivery propriety of baggage in a delivery time period of a delivery scheme, that is to say, whether the baggage can be delivered, while a delivery person is delivering the baggage according to the delivery scheme.

The second delivery-in-progress processing is repeatedly executed in a target period of a delivery scheme. Note that, the second delivery-in-progress processing may be executed via the delivery person terminal 105 in response to a request from the delivery person.

The assessment unit 124 assesses whether a second condition is satisfied, regarding undelivered baggage among pieces of baggage whose delivery the delivery person is in charge of (step S301).

The second condition is a condition for assessing that the delivery person is about to deliver baggage to an address being a delivery destination of the baggage, and includes, for example, at least one of a condition A and a condition B below.
Condition A: A previously determined second time before a delivery time period of baggage.
Condition B: A current position of a delivery person is within a previously determined second range from an address being a delivery destination of baggage.

The second time is shorter than the first time, for example, about 1 to 3 minutes. The second range is narrower than the first range, for example, several meters to several ten meters.

In assessment under the condition A, the assessment unit 124 refers to the second storage unit 114, and extracts a baggage ID associated with a delivery person terminal ID of a delivery person in the delivery scheme data 122. Thereby, the assessment unit 124 extracts a baggage ID of undelivered baggage among pieces of baggage whose delivery the delivery person is in charge of. Note that, when the delivery scheme data 122 include data relating to baggage that is not undelivered, the assessment unit 124 may further extract a baggage ID of the undelivered baggage by use of delivery status information of the baggage data 120.

The assessment unit 124 assesses whether the condition A is satisfied, by whether a delivery time period associated with the extracted baggage ID is within a second time period from a current time instant. Specifically, it is assessed that the baggage satisfies the condition A when a delivery time period of baggage is within the second time from the current time instant. Moreover, when a delivery time period of the baggage is not within the second time from the current time instant, it is assessed that the baggage does not satisfy the condition A.

In assessment under the condition B, the second position acquisition unit 118 inquires of the delivery person terminal 105 indicated by a delivery person terminal ID about a current position. When receiving the inquiry, the second position transmitting unit 111 acquires the current position, and transmits second position information indicating the acquired current position to the delivery assistance apparatus 104. Thereby, the second position acquisition unit 118 acquires the current position of the delivery person of the baggage.

The assessment unit 124 assesses whether the condition B is satisfied, by whether a current position indicated by the second position information is within a second range from an address included in destination information of the baggage data 120, regarding baggage whose baggage ID is associated with the delivery person terminal ID in the delivery scheme data 122. Specifically, it is assessed that, when a current position is within a second range from an address being a delivery destination of baggage, the baggage satisfies the condition B. Moreover, when a current position is not within a second range from an address being a delivery destination of baggage, it is assessed that the baggage does not satisfy the condition B.

In a case where the second condition includes both the conditions A and B, the assessment unit 124 may assess that baggage satisfies the second condition when the baggage satisfies both the conditions A and B, and the baggage satisfies the condition, and may assess that baggage satisfies the second condition when the baggage satisfies either one of the conditions A and B.

When it is assessed that the second condition is not satisfied (step S301: No), the assessment unit 124 ends the second delivery-in-progress processing.

When it is assessed that the second condition is satisfied (step S301: Yes), the assessment unit 124 assesses whether the baggage assessed to satisfy the second condition is deliverable (step S302).

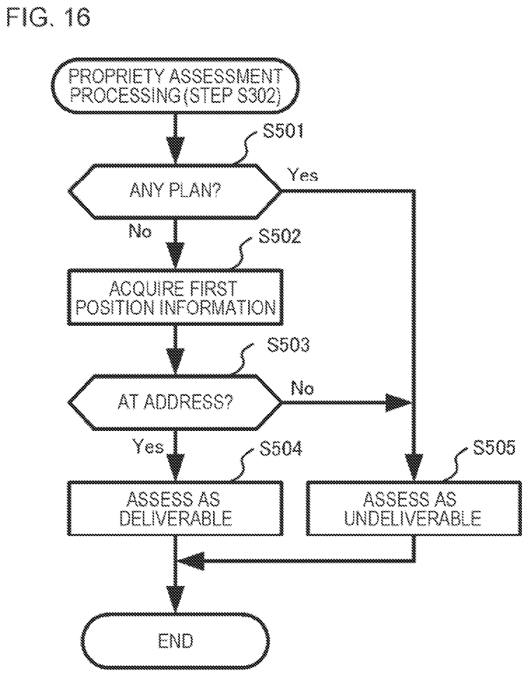

Specifically, in propriety assessment processing (step S302), the assessment unit 124 assesses whether a plan of a recipient is in a delivery time period of the baggage, as illustrated in FIG. 16 (step S501).

More specifically, the schedule acquisition unit 116 determines the first ID of the recipient data 121 including an address and a name common to the destination information of the baggage data 120, and acquires schedule data including the determined first ID. The schedule data 108 acquired in this instance may be data relating to the latest plan from a current time instant, or may be data relating to a plan within a previously determined time. Thereby, the schedule data 108 indicating a plan of the recipient of the baggage can be acquired.

The assessment unit 124 acquires a delivery time period associated in the delivery scheme data 122 with the baggage ID of the baggage assessed to satisfy the second condition. Then, the assessment unit 124 assesses, by use of the schedule data 108 acquired by the schedule acquisition unit 116, whether a plan of the recipient in the delivery time period of the baggage.

When it is assessed that the plan is not is in the delivery time period (step S501: No), the first position acquisition unit 117 acquires first position information of the recipient terminal 103 of the recipient of the baggage (step S502). Details of step S502 are substantially similar to those of step S202 described above. Thereby, the first position acquisition unit 117 acquires a current position of the recipient of the baggage.

By use of the first position information acquired in step S502, the assessment unit 124 assesses whether the recipient is at an address being a delivery destination of the baggage (step S503).

Specifically, the assessment unit 124 assesses whether the current position indicated by the first position information matches the address being the delivery destination of the baggage.

Herein, the address being the delivery destination of the baggage is an address included in the destination information associated with the baggage ID of the baggage in the baggage data 120.

Moreover, in determination of whether a current position matches an address, a measurement error of the current position may be considered. That is to say, when a current position is within a previously determined range from an address, it is assessed that the current position matches the address, and a recipient is at an address. Moreover, when a current position is not within a previously determined range from the address, it is assessed that the current position does not match the address, and a recipient is not at an address. The previously determined range herein is a range according to a measurement error.

When it is assessed that the recipient is at the address (step S503: Yes), the assessment unit 124 assesses that the baggage is deliverable (step S504), and returns to the second delivery-in-progress processing.

When it is assessed that the plan is in the delivery time period (step S501: Yes), or when it is assessed that a recipient is not at an address (step S503: No), the assessment unit 124 assesses that the baggage is deliverable (step S505), a return is made to the second delivery-in-progress processing.

In the propriety assessment processing (step S302) according to the present example embodiment, as described so far, delivery propriety of baggage in a delivery time period is assessed by use of both a current position and schedule data of the recipient. Note that, in the propriety assessment processing (step S302), delivery propriety of baggage in a delivery time period may be assessed by use of at least one of a current position and schedule data of the recipient.

FIG. 15 is referred to again.

When it is assessed that the baggage assessed to satisfy the second condition in step S301 is deliverable (step S302: Yes), the output control unit 125 transmits assistance information to the delivery person terminal 105 of the delivery person of the baggage (step S303). The assistance information transmitted herein includes the baggage ID of the baggage assessed to satisfy the second condition in step S301, and a fact that the baggage is deliverable.

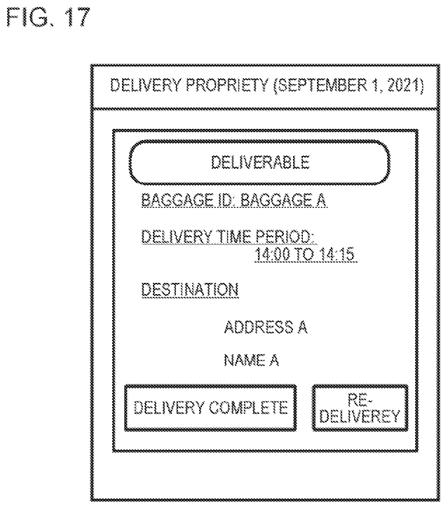

The assistance information transmitted from the output control unit 125 is displayed on the output unit 113 as described in connection with the scheme preparation processing. Herein, FIG. 17 illustrates one example of the screen of the output unit 113 displaying assistance information indicating that baggage is deliverable. This screen includes a “delivery complete” button and a “redeliver” button.

The “delivery complete” button is pressed by a delivery person when baggage has been handed over to a recipient. When the “delivery complete” button is pressed, the input acceptance unit 112 transmits, to the delivery assistance apparatus 104 via the network N, delivery completion information indicating, on the screen, a fact that delivery of the baggage associated with the “delivery complete” button has been completed.

The “redelivery” button is pressed by a delivery person when the delivery person has delivered baggage to a delivery destination, but a recipient has not responded thereto, and the baggage has not been able to be handed over to the recipient. When the “redelivery” button is pressed, the input acceptance unit 112 transmits, to the delivery assistance apparatus 104 via the network N, redelivery information indicating that baggage associated with the “redelivery” button on the screen is a target of redelivery.

FIG. 15 is referred to again.

The output control unit 125 assesses, according to whether delivery completion information has been acquired, whether the delivery of the baggage assessed to satisfy the second condition in step S301 has been completed.

When delivery completion information has not been acquired, the output control unit 125 assesses that the delivery of baggage has not been completed (step S304: No). In this case, the output control unit 125 assesses, according to whether redelivery information has been acquired, whether the baggage assessed to satisfy the second condition in step S301 is a target of redelivery (step S305).

When redelivery information has not been acquired, the output control unit 125 assesses that the baggage is not a target of redelivery (step S305: No), and a return is made to step S304.

When delivery completion information is acquired, the output control unit 125 assesses that delivery of the baggage has been completed (step S304: Yes). In this case, the output control unit 125 sets “delivery complete” to the delivery status information of the baggage data 120 of the baggage assessed to satisfy the second condition in step S301 (step S306).

The output control unit 125 deletes, from the second storage unit 114, the delivery scheme data 122 relating to the baggage assessed to satisfy the second condition in step S301 (step S307).

Thereby, baggage that has completed delivery is excluded from baggage to be delivered in a target period of the delivery scheme.

The output control unit 125 transmits assistance information including a baggage ID and a delivery time period included in the delivery scheme data 122 of the baggage to be delivered by the delivery person (step S308). A transmission destination herein is the delivery person terminal 105 of the delivery person of the baggage determined to satisfy the second condition in step S301. Thereby, the output control unit 125 ends the second delivery-in-progress processing.

When it is assessed that the baggage assessed to satisfy the second condition in step S301 is undeliverable, that is to say, is not deliverable (step S302: No), the output control unit 125 transmits assistance information to the delivery person terminal 105 of the delivery person of the baggage (step S309). The assistance information transmitted herein includes the baggage ID of the baggage assessed to satisfy the second condition in step S301, and a fact that the baggage is undeliverable.

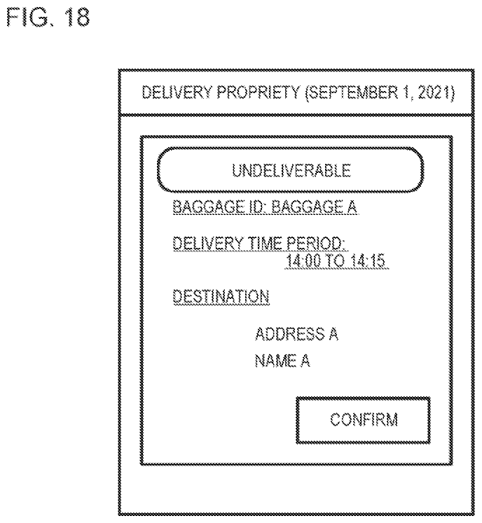

Herein, FIG. 18 illustrates one example of a screen of the output unit 113 displaying assistance information indicating that baggage is undeliverable. The screen includes a “confirm” button. The “confirm” button is pressed by a delivery person who has confirmed a content of the screen. When the “confirm” button is pressed, the input acceptance unit 112 causes the output unit 113 to end display of the assistance information indicating that the baggage is undeliverable.

Herein, as described with reference to FIGS. 17 and 18, when the output unit 113 is caused to display assistance information indicating delivery propriety, the output control unit 125 causes the output unit 113 to display information indicating whether delivery of the baggage is possible. This can prevent a delivery person from knowing privacy of a recipient, such as whether the recipient is at an address or out. Therefore, it becomes possible to protect privacy of the recipient.

FIG. 15 is referred to again.

When it is assessed that the baggage is a target for redelivery (step S305: Yes), or subsequently to processing in step S309, the output control unit 125 executes the processing in step S310. In step S310, the output control unit 125 sets “redelivery” in delivery status information of the baggage data 120 of the baggage assessed to satisfy the second condition in step S301.

The output control unit 125 deletes, from the second storage unit 114, the delivery scheme data 122 relating to the baggage assessed to satisfy the second condition in step S301 (step S311).

Thereby, the baggage assessed to satisfy the second condition in step S301 has become a target for redelivery, and is therefore excluded from baggage to be delivered in a target period of the delivery scheme.

The output control unit 125 executes processing in step S308 described above, and ends the second delivery-in-progress processing.

The second delivery-in-progress processing according to the present example embodiment assesses delivery propriety of baggage in a delivery time period by use of at least one of a current position and the schedule data 108 of a recipient, regarding baggage satisfying the second condition.

Baggage satisfying the second condition is baggage to be delivered soon, as described above. In such a case, when a recipient has no plan for a delivery time period and the recipient is at an address, a possibility that the baggage can be handed over to the recipient is high. On the contrary, when a recipient has a plan for a delivery time period, or when the recipient is not at an address, a possibility that the baggage cannot be handed over to the recipient is low.

Thus, by assessing delivery propriety of baggage immediately before delivery, the baggage is delivered when a possibility that the baggage can be handed over to the recipient is a high, or the baggage can be redelivered when the possibility is low. Therefore, it becomes possible to assist a further improvement in delivery efficiency of baggage.

So far, the first example embodiment according to the present invention has been described.

According to the present example embodiment, the delivery assistance apparatus 104 causes the output unit 113 to display assistance information indicating a delivery time period or delivery propriety of the baggage, by use of the schedule data 108 of the recipient determined by destination information of the baggage

Thereby, a possibility that a recipient cannot receive baggage at delivery, such as absence of a recipient, or a situation where a recipient is at an address but cannot respond to delivery of the baggage can be reduced. Therefore, it becomes possible to assist an improvement in delivery efficiency of baggage. Moreover, a reduction of effort for receiving baggage, such as effort for a recipient to respond to redelivery, can be made. Therefore, it becomes possible to make an improvement in convenience for a recipient.

The first example embodiment according to the present invention may be modified as follows.

### First Modified Example

In scheme preparation processing according to the first example embodiment, an example has been described in which a delivery scheme of baggage is prepared regardless of a current position of a recipient. However, during the scheme preparation processing, when a recipient is on a business trip or the like and is thus in a place far away from an address being a delivery destination of baggage, there is a high possibility that a delivery person delivers baggage but cannot hand over the baggage to the recipient.

Thus, when a recipient is in a remote location during execution of the scheme preparation processing, baggage of the recipient may be targeted for redelivery, and excluded from the baggage to be a target for the scheme preparation processing.

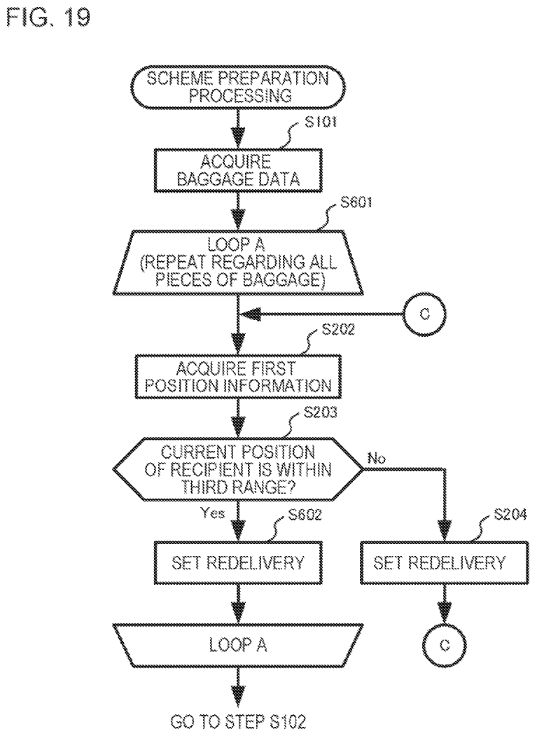

In the scheme preparation processing according to a first modified example, as illustrated in FIG. 19, processing in step S101 similar to that according to the first example embodiment is performed. Thereafter, processing substantially similar to that in steps S202 to S204 is repeated for all pieces of baggage relating to the baggage data 120 acquired in step S101 (loop A: step S601).

In step S202 according to the present modified example, a first position acquisition unit 117 acquires first position information by inquiring a recipient terminal 103 of a recipient determined by destination information acquired in step S101 about a current position.

In step S203 according to the present modified example, a schedule acquisition unit 116 assesses, by use of the first position information acquired in step S202, whether a current position of the recipient is within a previously determined third range.

Herein, a range where a recipient is far from an address is set to the third range. The far range from the address is a range previously determined from the address. The range is a range where a recipient exceeds a distance that is difficult to travel in a target period of a delivery scheme, and is, for example, a range that exceeds several hundred kilometers.

When a recipient is far from an address, as described above, there is a low possibility that the recipient is at the address in a target period. By the assessment processing in step S203 according to the present modified example, whether there is a high possibility that the recipient is at the address in the target period of the delivery scheme can be assessed.

“Being within the third range” in step S203 according to the present modified example is another example of a previously determined first condition.

When a current position of the recipient is not within the third range (step S203: No), a determination unit 123 sets “redelivery” in delivery status information of the baggage data 120 of baggage being a target of processing (step S204), similarly to the first example embodiment.

When a current position of the recipient is within the third range (step S203: No), the schedule acquisition unit 116 holds a baggage ID of baggage of the recipient (step S602).

When processing in steps S202 to S204 ends regarding all pieces of baggage relating to the baggage data 120 acquired in step S101 (loop A), scheme preparation processing in and after step S102 is executed for baggage of the baggage ID held in step S602.

That is to say, for example, in step S102 according to the present modified example, schedule data 108 of the recipient determined by destination information associated with the baggage ID held in step S602 in the baggage data 120 are acquired from the schedule management apparatus 102.

According to the present modified example, a possibility that a recipient is absent and therefore cannot receive baggage at delivery can be reduced. Therefore, it becomes possible to assist an improvement in delivery efficiency of baggage.

### Second Modified Example

In the first example embodiment, a case where a person who receives baggage is a recipient determined by destination information of the baggage has been described as an example. However, there is also a case where baggage is received by a person other than a recipient, such as a housemate of the recipient.

In the present modified example, an example is described in which, in addition to a recipient determined by destination information of baggage, the baggage can also be received by a reception proxy previously determined in association with the recipient.

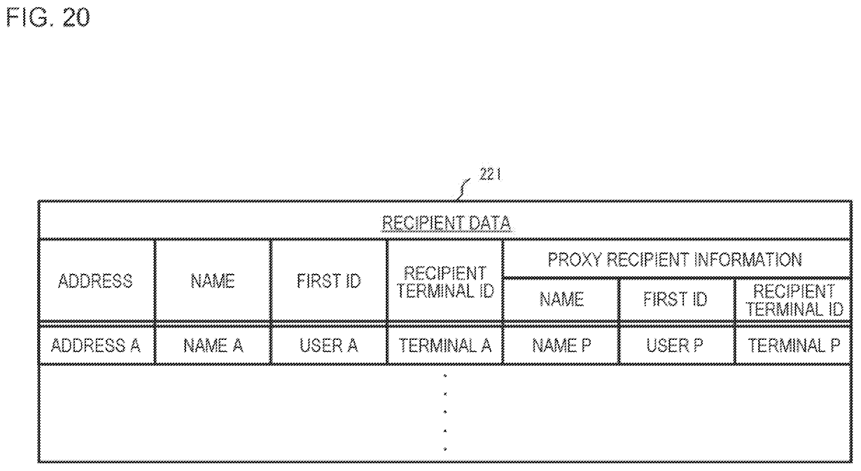

Recipient data 221 according to the present modified example are data that replace recipient data 121 according to the first example embodiment. The recipient data 221 include, as one example thereof is illustrated in FIG. 20, proxy recipient information in addition to an address, a name, a first ID, and a recipient terminal ID similar to those according to the first example embodiment, which are associated with each other.

The proxy recipient information is information relating to a proxy recipient, and is set in association with the recipient, for example, with consent of both the recipient and the proxy recipient. The proxy recipient information includes, for example, a name, a first ID, and a recipient terminal ID of a second recipient. The recipient terminal ID included in the proxy recipient information is information for identifying a recipient terminal 103 owned by the second recipient, and is set to a contact point of the recipient terminal 103.

The recipient data 221 are associated with proxy recipient information relating to a proxy recipient of a recipient determined by an address and a name. A detailed example of the recipient data 121 illustrated in the figure indicates that a name, a first ID, and a recipient terminal ID of the proxy recipient information are “name P,” “user P”, and “terminal P”, respectively.

Note that, in the recipient data 221, one recipient may be associated with proxy recipient information relating to a plurality of proxy recipients.

In the present modified example, substantially, a recipient in the description of the first example embodiment may be replaced with an eligible recipient including the recipient and a proxy recipient thereof.

Herein, an eligible recipient is a person who is eligible to receive baggage, and is a generic term for a recipient and a reception proxy. Since the eligible recipient includes at least the recipient, there are a plurality of eligible recipients when the reception proxy is set as in the present modified example.

For example, an assistance unit 119 can cause an output unit 113 to display assistance information indicating a delivery time period or delivery propriety of baggage, by use of schedule data 108 of an eligible recipient including a recipient determined by destination information of baggage and a reception proxy thereof.

Specifically, for example, a determination unit 123 can determine a delivery time period of baggage by use of the schedule data 108 of the eligible recipient. Moreover, when a current position of the eligible recipient satisfies a previously determined first condition, the determination unit 123 can determine a delivery time period of baggage by use of the schedule data 108 of the eligible recipient.

An assessment unit 124 can assess delivery propriety of baggage in a delivery time period of the baggage by use of at least one of a current position and schedule data of the eligible recipient. Moreover, when a second condition is satisfied, the assessment unit 124 can assess delivery propriety of baggage in a delivery time period of the baggage by use of at least one of a current position and the schedule data of the eligible recipient.

An output control unit 125 can cause an output unit 113 to output the assistance information, similarly to the first example embodiment.

According to the present modified example, in addition to a recipient determined by destination information of baggage, a plurality of eligible recipients including a reception proxy can receive the baggage. Thereby, a possibility that the baggage can be received can be heightened.

Therefore, it becomes possible to assist a further improvement in delivery efficiency of baggage. Moreover, a further reduction in effort for receiving baggage, such as effort for a recipient to respond to redelivery, can be made. Therefore, it becomes possible to make a further improvement in convenience for a recipient.

### Third Modified Example

In the first example embodiment, an example has been described in which a determination unit 123 determines a delivery time period of baggage by use of schedule data 108 of a recipient. However, the determination unit 123 may determine a delivery time period of baggage by use of a current position of a recipient. In this case, as described in the first example embodiment, an assessment unit 124 may assess delivery propriety of baggage in a delivery time period of the baggage by use of at least one of a current position and the schedule data 108 of the recipient.

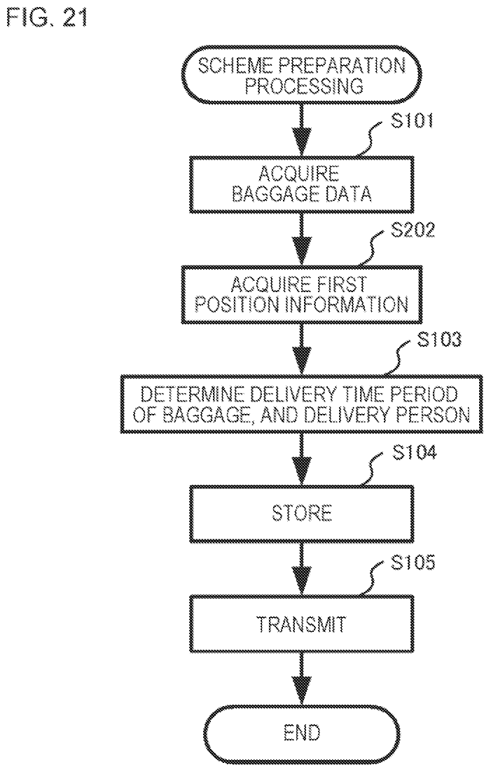

In scheme preparation processing according to a third modified example, as illustrated in FIG. 21, processing in step S202 is performed instead of step S102 according to the first example embodiment.

That is to say, in scheme preparation processing according to the present modified example, processing in step S101 similar to that according to the first example embodiment is performed. Thereafter, processing in step S202 is executed regarding all pieces of baggage relating to baggage data 120 acquired in step S101.

In step S202 according to the present modified example, a first position acquisition unit 117 acquires first position information by inquiring a recipient terminal 103 of a recipient determined by destination information acquired in step S101 about a current position.

In step S103 according to the present modified example, a determination unit 123 determines a delivery time period of baggage by use of a current position of the recipient terminal 103 acquired in step S202, and determines a delivery person of the baggage.

Specifically, in a case of baggage for which a reception time is not set in the baggage data 120 acquired in step S101, the determination unit 123 determines a delivery time period of the baggage by use of the current position acquired in step S202. Moreover, in a case of baggage for which a reception time is set in the baggage data 120 acquired in step S101, the determination unit 123 determines a delivery time period of the baggage by use of the reception time, and the current position acquired in step S202.

For example, the determination unit 123 may determine a delivery time period of the baggage according to a distance between the current position acquired in step S202 and an address included in destination information of the baggage.

More specifically, for example, the determination unit 123 estimates a necessary time required to travel a distance between a current position and an address being a delivery destination of baggage, and determines, as a delivery time period of the baggage, a time period when equal to or more than the necessary time has passed since the execution time of the scheme preparation processing.

Moreover, in a case of baggage for which a reception time has been set, the determination unit 123 determines, as a delivery time period of the baggage, a time period when a time equal to or more than equal to or more than the necessary time has passed since execution of the scheme preparation processing, within a set reception time.

The scheme preparation processing according to the present modified example prepares a delivery scheme with reference to a current position of a recipient. Thus, a possibility that a recipient is absent and therefore cannot receive baggage at delivery can be reduced. Therefore, it becomes possible to assist an improvement in delivery efficiency of baggage. Moreover, a reduction in effort for receiving baggage, such as effort for a recipient to respond to redelivery, can be made. Therefore, it becomes possible to make an improvement in convenience for a recipient.

### Second Example Embodiment

In a second example embodiment according to the present invention, an example is described in which, in a case where a reception time of baggage is specified, a recipient is notified that the baggage is delivered when a plan is changed in schedule data 108 of a recipient at a time being relevant to the reception time.

A delivery assistance system according to the second example embodiment includes a delivery assistance apparatus 304 that replaces a delivery assistance apparatus 104 according to the first example embodiment. Except for this point, the delivery assistance system according to the present example embodiment may be configured similarly to a delivery assistance system 100 according to the first example embodiment.

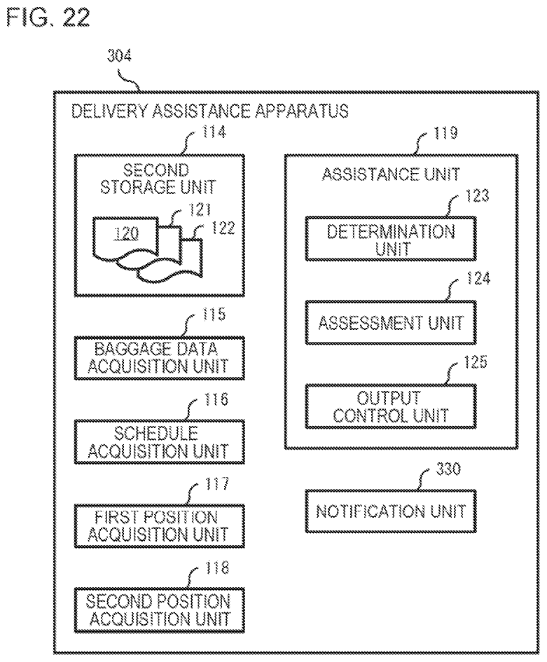

The delivery assistance apparatus 304 functionally includes a notification unit 330 in addition to a configuration of the delivery assistance apparatus 104 according to the first example embodiment, as illustrated in FIG. 22. Except for this point, the delivery assistance apparatus 304 according to the present example embodiment may be configured similarly to the delivery assistance apparatus 104 according to the first example embodiment.

The notification unit 330 notifies, in a case where a reception time of the baggage is specified, the recipient that the baggage is delivered when there is a change in the schedule data 108 of the recipient at a time being relevant to the reception time.

The delivery assistance system according to the present example embodiment may be physically configured similarly to the delivery assistance system 100 according to the first example embodiment.

The delivery assistance system according to the present example embodiment executes a delivery assistance method similarly to the delivery assistance system 100 according to the first example embodiment. The delivery assistance method according to the present example embodiment executes notification processing in addition to scheme preparation processing, first delivery-in-progress processing, and second delivery-in-progress processing that are similar to those according to the first example embodiment.

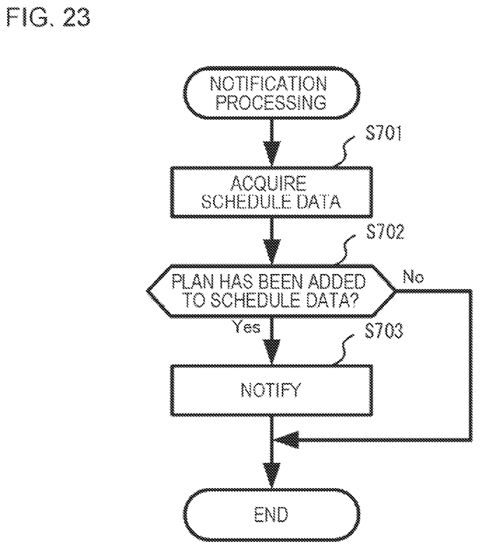

FIG. 23 is a flowchart illustrating one example of notification processing according to the present example embodiment. The notification processing is processing for notifying a recipient that baggage is delivered, and is repeatedly executed in a target period. The notification processing according to the present example embodiment is executed for baggage for which a reception time is specified among pieces of baggage planned to be delivered in the target period.

The baggage planned to be delivered in the target period is baggage whose delivery status information in the baggage data 120 is “undelivered”. It is assumed that the schedule data 108 acquired in step S102 or the like of the scheme preparation processing are stored in a second storage unit 114.

The schedule acquisition unit 116 acquires, from a schedule management apparatus 102, the schedule data 108 of a recipient determined by destination information of the baggage data 120, regarding baggage for which a reception time is specified among pieces of baggage planned to be delivered in a target period (step S701).

Details of the method of acquiring the schedule data 108 in step S701 are substantially similar to those of the method of acquiring the schedule data 108 in step S102.

Note that, a communication unit 107 may detect a change in the schedule data 108, and transmit the schedule data 108 after the change. Thereby, the schedule acquisition unit 116 may acquire the schedule data 108 of the recipient from the schedule management apparatus 102 in step S701.

The notification unit 330 compares the latest schedule data 108 stored in the second storage unit 114 with the schedule data 108 acquired in step S701, regarding the common recipient. Thereby, the notification unit 330 assesses whether a plan for a time being relevant to a reception time has been added to the schedule data 108 acquired in step S701 (step S702).

When it is assessed that no plan has been added to the schedule data 108 (step S702: No), the notification unit 330 ends the notification processing.

When it is assessed that a plan has been added to the schedule data 108 (step S702: Yes), the notification unit 330 notifies the recipient terminal 103 that baggage is delivered at the reception time (step S703). Thereby, the recipient can be notified that the baggage is delivered at the reception time.

So far, the second example embodiment according to the present invention has been described.

According to the present example embodiment, in a case where a delivery time of baggage is specified, a recipient is notified that the baggage is delivered, when there is a change in a plan of the schedule data 108 of the recipient at a time being relevant to the reception time. Particularly, in the present example embodiment, when a plan is added to the schedule data 108 of the recipient at a time being relevant to a reception time, the recipient is notified that the baggage is delivered.

When there is a change in a plan of the schedule data 108 of the recipient at a time being relevant to the reception time, particularly when a plan is added, there is a concern that the recipient may have forgotten specifying a reception time of baggage. In the present example embodiment, the recipient is notified of delivery of the baggage, and, therefore, the recipient can be alerted thereto.

Thereby, a possibility that a recipient cannot receive baggage can be reduced. Therefore, it becomes possible to assist a further improvement in delivery efficiency of baggage. Moreover, a reduction in effort for receiving baggage, such as effort for a recipient to respond to redelivery, can be made. Therefore, it becomes possible to make a further improvement in convenience for a recipient.

The second example embodiment according to the present invention may be modified as follows.

### Fourth Modified Example

In a second example embodiment, an example has been described in which a recipient is notified of delivery of baggage when there is a change in a plan of schedule data 108 of the recipient. However, a case where a recipient is notified of delivery of baggage is not limited thereto. In a fourth modified example, an example is described in which a recipient is notified of delivery of baggage when a current position of the recipient a previously determined time (e.g., a first time described above) before a reception time is not within a previously determined range (e.g., a first range included in a first condition described above).

In the present modified example, notification processing different from that according to the second example embodiment is executed. A difference between notification processing according to the present modified example and notification processing according to the second example embodiment is mainly described below.

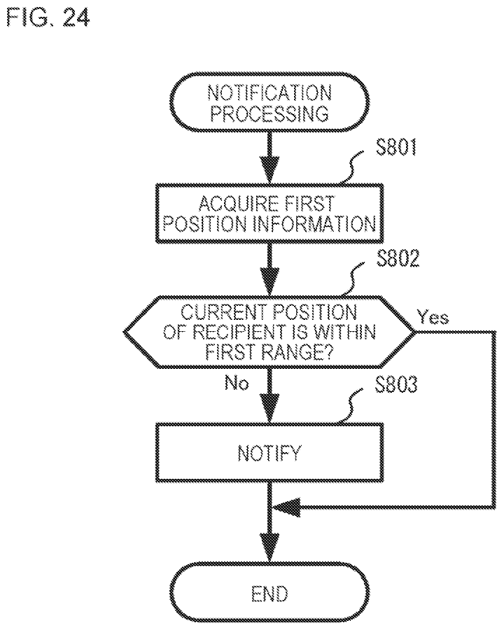

FIG. 24 is a flowchart illustrating one example of notification processing according to the present modified example.

The first position acquisition unit 117 acquires first position information by inquiring of a recipient terminal 103 of a recipient of baggage planned to be delivered in a target period about a current position (step S801).

Details of a method of acquiring first position information in step S801 are substantially similar to those of the method of acquiring first position information in step S202.

The notification unit 330 assesses, by use of the first position information acquired in step S801, whether a current position of the recipient is within a previously determined first range (step S802).

Details of the assessment processing in step S802 are substantially similar to those of the assessment processing in step S203.

When a current position of the recipient is within the first range (step S802: Yes), the notification unit 330 ends the notification processing.

When a current position of the recipient is not within the first range (step S802: No), the notification unit 330 notifies the recipient terminal 103 that the baggage is delivered at a reception time (step S803). Thereby, the recipient can be notified that the baggage is delivered at the reception time.

According to the present modified example, in a case where a delivery time of baggage is specified, a recipient is notified that the baggage is delivered, when a first condition that a current position of the recipient a previously determined time before a reception time is within the first range is not satisfied.

When a recipient is not in a vicinity of an address at a time relatively close to a reception time, there is a concern that the recipient may have forgotten specifying a reception time of baggage. In the present modified example, similarly to the second example embodiment, the recipient is notified of delivery of the baggage, and, therefore, the recipient can be alerted thereto.

Thereby, a possibility that a recipient cannot receive baggage can be reduced. Therefore, it becomes possible to assist a further improvement in delivery efficiency of baggage. Moreover, a reduction in effort for receiving baggage, such as effort for a recipient to respond to redelivery, can be made. Therefore, it becomes possible to make a further improvement in convenience for a recipient.

### Fifth Modified Example

In the second example embodiment, an example has been described in which, in a case where a reception time of baggage is specified, a recipient is notified that the baggage is delivered, when a plan is changed in schedule data 108 of the recipient at a time being relevant to the reception time. In a fifth modified example, an example is described in which a recipient is inquired of about re-specification of a reception time in a similar case.

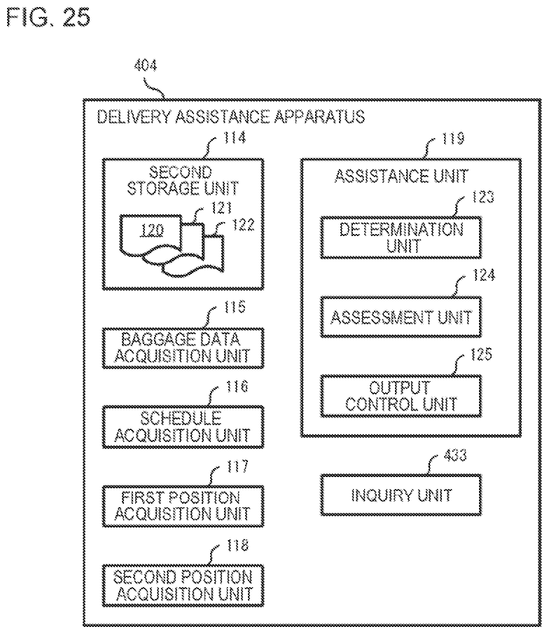

A delivery assistance apparatus 404 according to the present modified example functionally includes an inquiry unit 433 that replaces a notification unit 330, as illustrated in FIG. 25. Except for this point, the delivery assistance apparatus 404 may be configured similarly to a delivery assistance apparatus 304 according to the second example embodiment.

The inquiry unit 433 inquires, in a case where a reception time of baggage is specified, of a recipient about re-specification of a reception time, when there is a change in schedule data 108 of the recipient at a time being relevant to the reception time.

In a delivery assistance system according to the present modified example, inquiry processing that replaces notification processing according to the second example embodiment is executed.

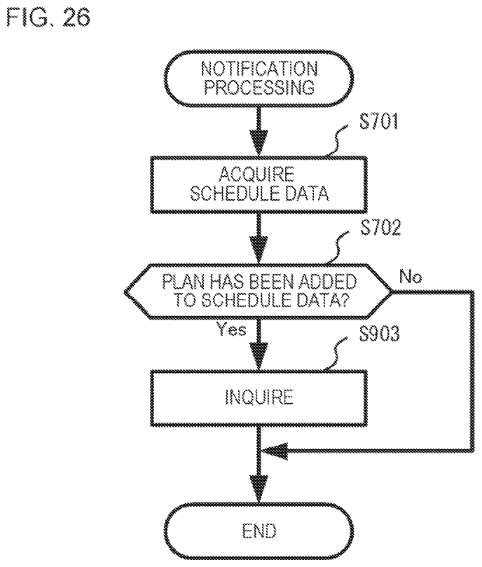

FIG. 26 is a flowchart illustrating one example of inquiry processing according to the present modified example. The inquiry processing is processing for inquiring of a recipient about re-specification of a reception time of baggage, and is repeatedly executed in a target period. The inquiry processing according to the present modified example is executed for baggage for which a reception time is specified among pieces of baggage planned to be delivered in a target period.

Baggage planned to be delivered in a target period is baggage whose delivery status information in baggage data 120 is “undelivered”. It is assumed that the schedule data 108 acquired in step S102 or the like of scheme preparation processing are stored in a second storage unit 114.

Processing in steps S701 and S702 similar to that according to the second example embodiment is performed.

Note that, the inquiry unit 433 may detect a change in the schedule data 108, and transmit the schedule data 108 after the change. Thereby, a schedule acquisition unit 116 may acquire the schedule data 108 of the recipient from a schedule management apparatus 102 in step S701.

Moreover, the processing in step S702 is executed by the inquiry unit 433 instead of the notification unit 330 according to the second example embodiment.

When it is assessed that no plan has been added to the schedule data 108 (step S702: No), the inquiry unit 433 ends the notification processing.

When it is assessed that a plan has been added to the schedule data 108 (step S702: Yes), the inquiry unit 433 inquires of the recipient terminal 103 about re-specification of a reception time (step S903). Thereby, the recipient can be inquired of about re-specification of a reception time.

According to the present modified example, in a case where a reception time of baggage is specified, a recipient is inquired of about re-specification of a reception time, when there is a change in a plan of the schedule data 108 of the recipient at a time being relevant to the reception time. Particularly, in the present example embodiment, when a plan is added to the schedule data 108 of the recipient at a time being relevant to a reception time, the recipient is inquired of about re-specification of a reception time.

When there is a change in a plan of the schedule data 108 of a recipient at a time being relevant to a reception time, particularly when a plan is added, there is a concern that the recipient may have forgotten specifying a reception time of baggage. In the present modified example, when a recipient who has received an inquiry has difficulty in receiving baggage, a reception time can be re-specified.

Thereby, a possibility that a recipient cannot receive baggage can be reduced. Therefore, it becomes possible to assist a further improvement in delivery efficiency of baggage. Moreover, since a recipient can easily re-specify a reception time, a reduction in effort for receiving baggage can be made. Therefore, it becomes possible to make a further improvement in convenience for a recipient.

### Sixth Modified Example

In the fifth modified example, an example has been described in which a recipient is inquired of about re-specification of a reception time when there is a change in a plan of schedule data 108 of the recipient. However, a case where a recipient is inquired of about re-specification of a reception time is not limited thereto. In a sixth modified example, an example is described in which a recipient is inquired of about re-specification of a reception time when a current position of the recipient a previously determined time (e.g., a first time described above) before a reception time is not within a previously determined range (e.g., a first range included in a first condition described above).

In the present modified example, inquiry processing different from that according to the fifth modified example is executed. A point different from the inquiry processing according to the fifth modified example is mainly described below regarding the inquiry processing according to the present modified example.

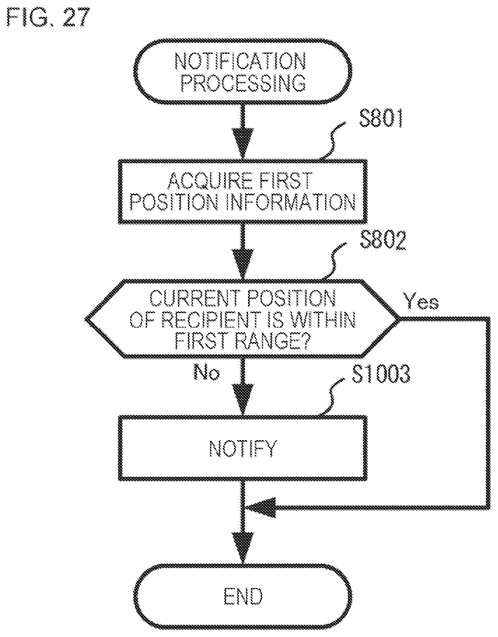

FIG. 27 is a flowchart illustrating one example of the inquiry processing according to the present modified example.

Processing in steps S801 and S802 similar to that according to the fourth modified example is performed.

Note that, processing in step S802 is executed by an inquiry unit 433 instead of a notification unit 330 according to the fourth modified example.

When a current position of a recipient is within a first range (step S802: Yes), the inquiry unit 433 ends notification processing.

When a current position of the recipient is not within the first range (step S802: No), the inquiry unit 433 inquires of the recipient terminal 103 about re-specification of a reception time (step S1003). Thereby, the recipient can be inquired of about re-specification of a reception time.

According to the present modified example, in a case where a reception time of baggage is specified, a recipient is inquired of about re-specification of a reception time, when a first condition that a current position of the recipient a previously determined time before a reception time is within the first range is not satisfied.

When a recipient is not in a vicinity of an address at a time relatively close to a reception time, there is a concern that the recipient may have forgotten specifying a reception time of baggage. In the present modified example, similarly to the fifth modified example, when a recipient who has received an inquiry has difficulty in receiving baggage, a reception time can be re-specified.

Thereby, a possibility that a recipient cannot receive baggage can be reduced. Therefore, it becomes possible to assist a further improvement in delivery efficiency of baggage. Moreover, since a recipient can easily re-specify a reception time, a reduction in effort for receiving baggage can be made. Therefore, it becomes possible to make a further improvement in convenience for a recipient.

### Third Example Embodiment

In a third example embodiment according to the present invention, an example is described in which of a delivery scheme is corrected by determining a delivery time period of baggage, when a change has occurred in schedule data 108 of a recipient.

A delivery assistance system according to the third example embodiment includes a delivery assistance apparatus 504 that replaces a delivery assistance apparatus 104 according to the first example embodiment. Except for this point, the delivery assistance system according to the present example embodiment may be configured similarly to a delivery assistance system 100 according to the first example embodiment.

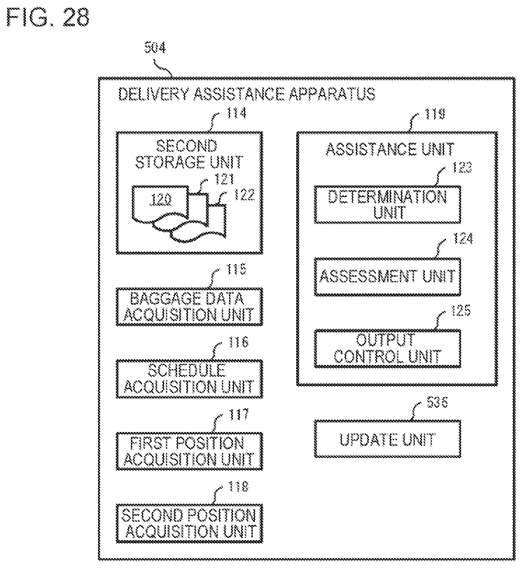

A delivery assistance apparatus 304 functionally includes an update unit 536 in addition to a configuration of the delivery assistance apparatus 104 according to the first example embodiment, as illustrated in FIG. 28. Except for this point, the delivery assistance apparatus 504 according to the present example embodiment may be configured similarly to the delivery assistance apparatus 104 according to the first example embodiment.

The update unit 536 determines a delivery time period of baggage whose plan has been changed, when a change has occurred in a plan indicated by the schedule data 108 of the recipient. Thereby, a delivery scheme prepared by scheme preparation processing is corrected.

The delivery assistance system according to the present example embodiment may be physically configured similarly to the delivery assistance system 100 according to the first example embodiment.

The delivery assistance system according to the present example embodiment executes a delivery assistance method similarly to the delivery assistance system 100 according to the first example embodiment. The delivery assistance method according to the present example embodiment executes notification processing in addition to scheme preparation processing, first delivery-in-progress processing, and second delivery-in-progress processing that are similar to those according to the first example embodiment.

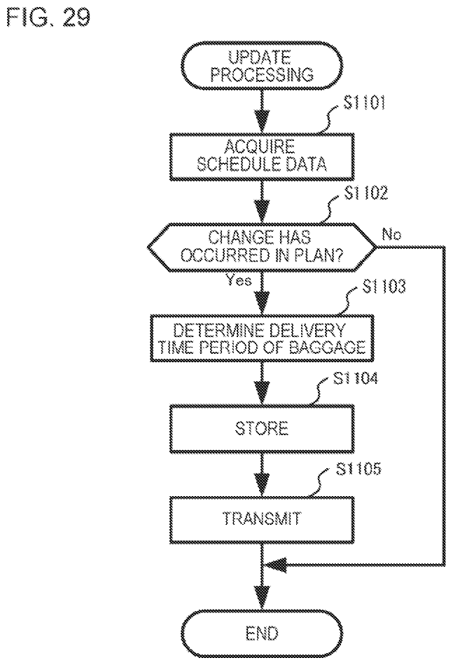

FIG. 29 is a flowchart illustrating one example of update processing according to the present example embodiment. The update processing is processing for correcting a delivery scheme when a change has occurred in the schedule data 108 of a recipient, and is repeatedly executed in a target period. The notification processing according to the present example embodiment is executed for undelivered baggage that is planned to be delivered in a target period.

Baggage that is undelivered in a target period is baggage for which delivery status information of baggage data 120 is “undelivered”. It is assumed that the schedule data 108 acquired in step S102 of the scheme preparation processing are stored in a second storage unit 114.

A schedule acquisition unit 116 acquires, from a schedule management apparatus 102, the schedule data 108 of a recipient determined by destination information of the baggage data 120, regarding baggage that is undelivered in a target period (step S1101).

Details of the method of acquiring the schedule data 108 in step S1101 are substantially similar to those of the method of acquiring the schedule data 108 in step S102.

Note that, a communication unit 107 may detect a change in the schedule data 108, and transmit the schedule data 108 after the change. Thereby, a schedule acquisition unit 116 may acquire the schedule data 108 of the recipient from a schedule management apparatus 102 in step S1101.

The update unit 536 compares the latest schedule data 108 stored in the second storage unit 114 with the schedule data 108 acquired in step S1101, regarding the common recipient. Thereby, the update unit 536 assesses whether a change has occurred in the schedule data 108 acquired in step S1101 (step S1102).

When it is assessed that no change has occurred in the schedule data 108 (step S1102: No), the update unit 536 ends the update processing.

When it is assessed that a change has occurred in the schedule data 108 (step S1102: Yes), the update unit 536 determines, by use of the schedule data 108 after the change, a delivery time period regarding baggage that is undelivered in a target period (step S1103). Thereby, the delivery scheme prepared by the scheme preparation processing is corrected.

Details of the method of determining a delivery time period in step S1103 are substantially similar to those of the determination method of a delivery time period in step S103.

The update unit 536 stores, in the second storage unit 114, delivery scheme data 122 indicating the corrected delivery scheme (step S1104).

Specifically, the update unit 536 updates the delivery time period of the delivery scheme data 122 by the delivery time period determined in step S1104, regarding baggage whose delivery time period determined in step S1104 is different from the delivery time period in the delivery scheme prepared by the scheme preparation processing.

The output control unit 125 transmits, to a delivery person terminal 105 of a delivery person of baggage whose delivery time period has been corrected in step S1103, assistance information including a baggage ID and a delivery time period included in the delivery scheme data 122 of baggage to be delivered by the delivery person (step S1105). Thereby, the output control unit 125 ends the update processing.

So far, the third example embodiment according to the present invention has been described.

According to the present example embodiment, when there is a change in a plan of the schedule data 108 of a recipient, a delivery scheme is corrected by use of the schedule data 108 after the change.

Thereby, since a delivery scheme according to the latest plan of a recipient can be prepared, a possibility that the recipient cannot receive baggage can be reduced. Therefore, it becomes possible to assist a further improvement in delivery efficiency of baggage. Moreover, a reduction in effort for receiving baggage, such as effort for a recipient to respond to redelivery, can be made. Therefore, it becomes possible to make a further improvement in convenience for a recipient.

The third example embodiment according to the present invention may be modified as follows.

### Seventh Modified Example

In the third example embodiment, an example has been described in which a delivery scheme is corrected by determining a delivery time period when there is a change in a plan of schedule data 108 of a recipient. However, a case where a delivery scheme is corrected is not limited thereto. An example is described in which, in a case where a reception time of baggage is specified, a delivery scheme is corrected when a plan is added to the schedule data 108 of the recipient at a time being relevant to a reception time.

In a case where a reception time of baggage is previously specified, when a plan is added to the schedule data 108 of a recipient at a time being relevant to a reception time, an update unit 536 according to the present modified example determines a delivery time period of baggage of the recipient to which the plan is added.

In the present modified example, update processing different from that according to a third example embodiment is executed. A point different from the update processing according to the third example embodiment is mainly described below regarding the update processing according to the present modified example.

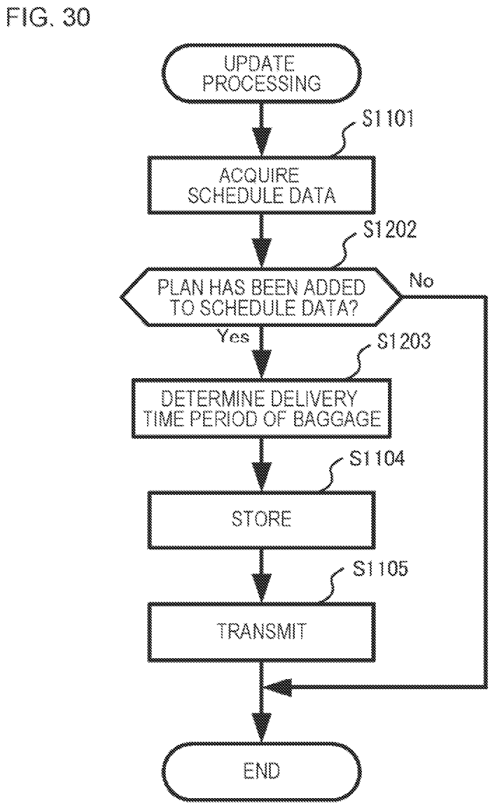

FIG. 30 is a flowchart illustrating one example of the update processing according to the present modified example.

Processing in step S1101 similar to that according to the third example embodiment is performed.

Similarly to the third example embodiment, the update unit 536 according to the present modified example compares the latest schedule data 108 stored in a second storage unit 114 with the schedule data 108 acquired in step S1101, regarding the common recipient. In the present modified example, the update unit 536 assesses whether a plan at a time being relevant to a reception time has been added to the schedule data 108 acquired in step S1101 (step S1202).

When it is assessed that no plan has been added to the schedule data 108 (step S1202: No), the update unit 536 ends the update processing.

When it is assessed that a plan has been added to the schedule data 108 (step S1202: Yes), the update unit 536 determines a delivery time period (step S1203). Specifically, the update unit 536 determines, by use of the schedule data 108 to which the plan has been added, a delivery time period regarding baggage that is undelivered in a target period in which a subject of the plan of the schedule data 108 is a recipient. Thereby, the delivery scheme prepared by the scheme preparation processing is corrected.

Details of the method of determining a delivery time period in step S1203 are substantially similar to those of the determination method of a delivery time period in step S103.

Processing similar that in steps S1104 and S1105 is executed. Thereby, the update processing ends.

According to the present modified example, in a case where a reception time of baggage is specified, when a plan of the schedule data 108 of the recipient at a time being relevant to a reception time is added, a delivery time period is determined regarding undelivered baggage for which a subject of a plan of the schedule data 108 is a recipient.

When a plan of the schedule data 108 of the recipient at a time being relevant to a reception time is added, there is a concern that the recipient may have forgotten specifying a reception time of baggage. In the present modified example, similarly to the second example embodiment, a delivery scheme is corrected by determining a delivery time period.

Thereby, since a delivery scheme according to the latest plan of a recipient can be prepared, a possibility that the recipient cannot receive baggage can be reduced. Therefore, it becomes possible to assist a further improvement in delivery efficiency of baggage. Moreover, a reduction in effort for receiving baggage, such as effort for a recipient to respond to redelivery, can be made. Therefore, it becomes possible to make a further improvement in convenience for a recipient.

### Eighth Modified Example

In a seventh modified example, an example has been described in which a delivery scheme is corrected by determining a delivery time period when a plan of schedule data 108 of a recipient is added. However, a case where a delivery scheme is corrected is not limited thereto. In an eighth modified example, an example is described in which, in a case where a reception time of baggage is specified, a delivery scheme is corrected when a current position of the recipient a previously determined time (e.g., a first time described above) before a reception time is not within a previously determined range (e.g., a first range included in a first condition described above).

In the present modified example, update processing different from that according to the seventh modified example is executed. A point different from the update processing according to the eighth modified example is mainly described below regarding the update processing according to the present modified example.

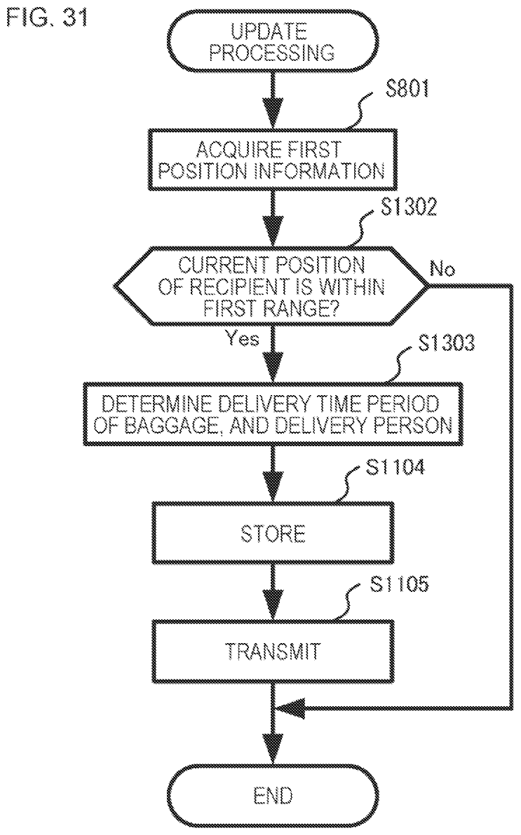

FIG. 31 is a flowchart illustrating one example of update processing according to the present modified example.

Processing similar to that in step S801 is executed.

An update unit 536 according to the present modified example determines, by use of first position information acquired in step S801, whether a current position of a recipient is within a previously determined first range (step S1302).

Details of assessment processing in step S1302 are substantially similar to those of assessment processing in step S203.

When a current position of the recipient is within the first range (step S1302: Yes), the update unit 536 ends the update processing.

When a current position of the recipient is not within the first range (step S1302; No), the update unit 536 determines a delivery time period regarding undelivered baggage of the recipient (step S1303). Thereby, the delivery scheme prepared by scheme preparation processing is corrected.

Details of the method of determining a delivery time period in step S1303 are substantially similar to those of the determination method of a delivery time period in step S103.

Processing similar to that in steps S1104 and S1105 is executed. Thereby, the update processing ends.

According to the present modified example, in a case where a reception time of baggage is specified, when a first condition that a current position of a recipient a previously determined time before a reception time is within the first range is not satisfied, a delivery time period is determined regarding undelivered baggage of the recipient.

When a recipient is not in a vicinity of an address at a time relatively close to a reception time, there is a concern that the recipient may have forgotten specifying a reception time of baggage. In the present modified example, similarly to the second example embodiment, a delivery scheme is corrected by determining a delivery time period.

Thereby, since a delivery scheme according to the latest plan of a recipient can be prepared, a possibility that the recipient cannot receive baggage can be reduced. Therefore, it becomes possible to assist a further improvement in delivery efficiency of baggage. Moreover, a reduction in effort for receiving baggage, such as effort for a recipient to respond to redelivery, can be made. Therefore, it becomes possible to make a further improvement in convenience for a recipient.

Although the example embodiments and the modified examples according to the present invention have been described above with reference to the drawings, the example embodiments and the modified examples are exemplifications according to the present invention, and various configurations other than those described above can also be adopted.

Moreover, although a plurality of processes (pieces of processing) are described in order in a plurality of flowcharts used in the above description, an execution order of processes executed in each example embodiment is not limited to the described order. In each example embodiment, an order of illustrated processes can be changed to an extent that causes no problem in terms of content. Moreover, the example embodiments and modified examples described above can be combined to an extent that content does not contradict.

Some or all of the above-described example embodiments can also be described as, but are not limited to, the following supplementary notes.
1. A delivery assistance apparatus including:
   a baggage information acquisition unit that acquires destination information of baggage; and
   an assistance unit that causes, by use of schedule data of an eligible recipient including a recipient determined by the destination information, an output unit to output assistance information indicating a delivery time period or delivery propriety of the baggage.
2. The delivery assistance apparatus according to supplementary note 1, wherein
   the assistance unit includes
   a determination unit that determines a delivery time period of the baggage by use of schedule data of the eligible recipient,
   an assessment unit that assesses delivery propriety of the baggage in a delivery time period of the baggage by use of at least one of a current position and schedule data of the eligible recipient, and
   an output control unit causes an output unit to output the assistance information.
3. The delivery assistance apparatus according to supplementary note 2, wherein,
   when a current position of the eligible recipient satisfies a previously determined first condition, the determination unit determines a delivery time period of the baggage by use of schedule data of the eligible recipient.
4. The delivery assistance apparatus according to supplementary note 2 or 3, wherein,
   when a previously determined second condition is satisfied, the assessment unit assesses delivery propriety of the baggage in a delivery time period of the baggage by use of at least one of a current position and schedule data of the eligible recipient.
5. The delivery assistance apparatus according to supplementary note 4, wherein
   the second condition includes at least one of being a previously determined time before a delivery time period of the baggage, and that a current position of a delivery person of the baggage is within a previously determined range from a delivery destination of the baggage.
6. The delivery assistance apparatus according to any one of supplementary notes 1 to 5, further including
   a notification unit for notifying, in a case where a reception time of the baggage is previously specified, the eligible recipient that the baggage is delivered, when a plan is added to schedule data of the eligible recipient at a time being relevant to the reception time, or when a current position of the eligible recipient at a previously determined time before the reception time does not satisfy a previously determined first condition.
7. The delivery assistance apparatus according to any one of supplementary notes 1 to 6, further including
   an inquiry unit for inquiring, in a case where a reception time of the baggage is previously specified, of the eligible recipient about re-specification of the reception time, when a plan is added to schedule data of the eligible recipient at a time being relevant to the reception time, or when a current position of the eligible recipient at a previously determined time before the reception time does not satisfy a previously determined first condition.
8. The delivery assistance apparatus according to any one of supplementary notes 1 to 7, further including
   an update unit for determining, in a case where a reception time of the baggage is previously specified, a delivery time period of the baggage, when a plan is added to schedule data of the eligible recipient at a time being relevant to the reception time, or when a current position of the eligible recipient at a previously determined time before the reception time does not satisfy a previously determined first condition.
9. The delivery assistance apparatus according to any one of supplementary notes 1 to 7, further including
   an update unit that determines a delivery time period of the baggage when a change has occurred in schedule data of the eligible recipient.
10. The delivery assistance apparatus according to any one of supplementary notes 1 to 9, wherein,
   when causing the output unit to output assistance information indicating the delivery propriety, the output control unit causes the output unit to output information indicating whether delivery of the baggage is possible.
11. The delivery assistance apparatus according to any one of supplementary notes 1 to 10, wherein
   the eligible recipient further includes a plurality of proxy recipients previously determined in association with a recipient determined by the delivery destination.
12. The delivery assistance apparatus according to supplementary note 1, wherein
   the assistance unit includes
   a determination unit that determines a delivery time period of the baggage by use of a current position of the eligible recipient,
   an assessment unit that assesses delivery propriety of the baggage in a delivery time period of the baggage by use of schedule data of the eligible recipient, and
   an output control unit causes an output unit to output the assistance information.
13. A delivery assistance system including:
   a delivery assistance apparatus including
   a baggage information acquisition unit that acquires destination information of baggage, and
   an assistance unit that transmits, by use of schedule data of an eligible recipient including a recipient determined by the destination information, assistance information indicating a delivery time period or delivery propriety of the baggage; and
   a delivery person terminal including an output unit that outputs the assistance information transmitted from the assistance unit, to a delivery person by an image or sound.
14. A delivery assistance method including:
   acquiring destination information of baggage; and
   causing, by use of schedule data of an eligible recipient including a recipient determined by the destination information, an output unit to output assistance information indicating a delivery time period or delivery propriety of the baggage.
15. A program for causing a computer to execute:
   acquiring destination information of baggage; and
   causing, by use of schedule data of an eligible recipient including a recipient determined by the destination information, an output unit to output assistance information indicating a delivery time period or delivery propriety of the baggage.

### REFERENCE SIGNS LIST

100 Delivery assistance system
101 Schedule management system
102 Schedule management apparatus
103 Recipient terminal
104, 304, 404, 504 Delivery assistance apparatus
105 Delivery person terminal
106 First storage unit
107 Communication unit
108 Schedule data
109 First position transmitting unit
110 Schedule management unit
111 Second position transmitting unit
112 Input acceptance unit
113 Output unit
114 Second storage unit
115 Baggage data acquisition unit
116 Schedule acquisition unit
117 First position acquisition unit
118 Second position acquisition unit
119 Assistance unit
120 Baggage data
121, 221 Recipient data
122 Delivery scheme data
123 Determination unit
124 Assessment unit
125 Output control unit
330 Notification unit
433 Inquiry unit
536 Update unit

What is claimed is:

1. A delivery assistance apparatus comprising:
at least one memory configured to store instructions; and
at least one processor configured to execute the instructions to:
acquire destination information of baggage; and
cause, by use of schedule data of an eligible recipient including a recipient determined by the destination information, an output unit to output assistance information indicating a delivery time period or delivery propriety of the baggage.

2. The delivery assistance apparatus according to claim 1, wherein
causing the output unit to output assistance information includes
determining the delivery time period of the baggage by use of the schedule data of the eligible recipient,
assessing the delivery propriety of the baggage in the delivery time period of the baggage by use of at least one of a current position and the schedule data of the eligible recipient, and
causing the output unit to output the assistance information.

3. The delivery assistance apparatus according to claim 2, wherein,
when the current position of the eligible recipient satisfies a previously determined first condition, the delivery time period of the baggage is determined by use of the schedule data of the eligible recipient.

4. The delivery assistance apparatus according to claim 2, wherein,
when a previously determined second condition is satisfied, the delivery propriety of the baggage in a delivery time period of the baggage is assessed by use of at least one of the current position and the schedule data of the eligible recipient.

5. The delivery assistance apparatus according to claim 4, wherein
the second condition includes at least one of being a previously determined time before the delivery time period of the baggage, and that a current position of a delivery person of the baggage is within a previously determined range from a delivery destination of the baggage.

6. The delivery assistance apparatus according to claim 1, the at least one processor configured further to execute the instructions to:
notify, in a case where a reception time of the baggage is previously specified, the eligible recipient that the baggage is delivered, when a plan is added to the schedule data of the eligible recipient at a time being relevant to the reception time, or when a current position of the eligible recipient at a previously determined time before the reception time does not satisfy a previously determined first condition.

7. The delivery assistance apparatus according to claim 1, the at least one processor configured further to execute the instructions to:
inquire, in a case where a reception time of the baggage is previously specified, of the eligible recipient about re-specification of the reception time, when a plan is added to the schedule data of the eligible recipient at a time being relevant to the reception time, or when a current position of the eligible recipient at a previously determined time before the reception time does not satisfy a previously determined first condition.

8. The delivery assistance apparatus according to claim 1, the at least one processor configured further to execute the instructions to:
determine, in a case where a reception time of the baggage is previously specified, the delivery time period of the baggage, when a plan is added to the schedule data of the eligible recipient at a time being relevant to the reception time, or when a current position of the eligible recipient at a previously determined time before the reception time does not satisfy a previously determined first condition.

9. The delivery assistance apparatus according to claim 1, the at least one processor configured further to execute the instructions to:
determine the delivery time period of the baggage when a change has occurred in the schedule data of the eligible recipient.

10. The delivery assistance apparatus according to claim 1, wherein,
when outputting the assistance information indicating the delivery propriety, the output information indicates whether delivery of the baggage is possible.

11. The delivery assistance apparatus according to claim 1, wherein
the eligible recipient further includes a plurality of proxy recipients previously determined in association with a recipient determined by the delivery destination.

12. The delivery assistance apparatus according to claim 1, wherein
causing the output unit to output assistance information includes
determining the delivery time period of the baggage by use of a current position of the eligible recipient,
assessing the delivery propriety of the baggage in the delivery time period of the baggage by use of the schedule data of the eligible recipient, and
causing the output unit to output the assistance information.

13. (canceled)

14. A delivery assistance method comprising:
acquiring destination information of baggage; and
causing, by use of schedule data of an eligible recipient including a recipient determined by the destination information, an output unit to output assistance information indicating a delivery time period or delivery propriety of the baggage.

15. A non-transitory storage medium storing a program for causing at least one computer to execute:
acquiring destination information of baggage; and
causing, by use of schedule data of an eligible recipient including a recipient determined by the destination information, an output unit to output assistance information indicating a delivery time period or delivery propriety of the baggage.
